(19) United States
(12) Patent Application Publication
(10) Pub. No.: US 2016/0314280 A1
(43) Pub. Date: Oct. 27, 2016

(54) Identification of Candidates for Clinical Trials

(71) Applicant: TRINETX, INC., Cambridge, MA (US)

(72) Inventors: David Fusari, Groton, MA (US); Laura Brass, Newton, MA (US)

(73) Assignee: TriNetX, Inc., Cambridge, MA (US)

(21) Appl. No.: 15/102,848

(22) PCT Filed: Dec. 9, 2014
(86) PCT No.: PCT/US14/69369

§ 371 Date: Jun. 8, 2016

Related U.S. Application Data
(60) Provisional application No. 61/913,809, filed on Dec. 9, 2013.

(51) Int. Cl. G06F 19/00; G06F 17/30

(52) U.S. Cl. CPC G06F 19/363; G06F 19/322; G06F 19/3418; G06F 17/30424

(57) ABSTRACT

A system, a method, and a computer program product for identifying candidates for a clinical study are disclosed. A subject matter query for a study is received. Based on the received subject matter query, a group of potential candidates for participating in the study is ascertained. The subject matter query is received at a federated data repository system storing heterogeneous data. The federated data repository system translates the subject matter query and based on the translated subject matter query, the group of potential candidates is ascertained.

### CROSS-REFERENCE TO RELATED APPLICATIONS

The present application claims priority to U.S. Provisional Patent Appl. No. 61/913,809 to Fusari, filed Dec. 9, 2013, and incorporates its disclosure herein by reference in its entirety.

### TECHNICAL FIELD

In some implementations, the current subject matter relates to data processing and in particular, to identification of candidates for clinical trials.

### BACKGROUND

Today, the process for pharmaceutical companies to identify and recruit cohort populations for clinical trials is costly, time inefficient, and highly fragmented. Approximately 30%-40% of clinical trials occur on time and/or meet the original proposed target recruitment numbers. Most companies do not use data to conduct feasibility testing or to design their inclusion/exclusion criteria for cohort segmentation. Instead, they rely on literature searches and anecdotal input/impressions from internal key opinion leaders (“KOLs”), which are more often than not inconsistent with the actual data. These inaccuracies invariably lead to delays and failures in patient recruitment.

Even where data is being used for feasibility testing and cohort segmentation, the process for acquiring and using data sets from third-party data providers (e.g., IMS Health, Wolters Kluwer, Thomson Reuters, etc.) is costly and inefficient. Data sets are licensed based on pre-validated hypotheses and inclusion/exclusion criteria. As a result, study physicians typically have to request multiple data sets over a period of time as their assumptions are refined, where each subsequent request can cost tens to hundreds of thousands of dollars and take weeks to months to process.

Provider site and patient recruitment are typically equally plagued by the lack of or inefficient use of data. Even where data is being used today, most third-party data sets are de-identified or anonymized. Consequently, targeted cohort segmentation can identify the number of potential trial candidates in a specific geographic region, but one cannot specifically identify the actual patient. This makes recruitment of that anonymous patient exceptionally time and labor intensive.

These delays and inefficiencies can result in millions of dollars in Institutional Review Board (“IRB”) Amendments and months of delays in initiating trials for therapeutics with potentially important impacts for patients in every area of disease.

### SUMMARY

In some implementations, the current subject matter relates to a computer-implemented method for identifying candidates for a study (e.g., a clinical study). The method can include receiving a subject matter query for a study, translating the received subject matter query for at least one target data repository, providing the translated subject matter query to at least one federated data repository, identifying, using the at least one federated data repository, at least one subject matching the subject matter query, and obtaining at least one additional statistical information associated with the at least one subject, wherein the obtained at least one additional statistical information is translated to common terminology, and ascertaining, based on the identified at least one subject, a group of potential candidates for participating in the study. At least one of the receiving, the translating, the providing, the identifying, and the ascertaining can be performed by at least one processor of at least one computing system.

In some implementations, the current subject matter can include one or more of the following optional features. The method can further include identifying, based on a protocol, at least one location and at least one principal investigator associated with the at least one location for conducting a study, the protocol containing subject matter for generating the subject matter query, and selecting, based on the identified at least one location and the at least one principal investigator, a first group of candidates to participate in the study, the at least one principal investigator conducts the study, the first group of candidates is selected from the group of potential candidates.

In some implementations, the study can be a clinical study and a protocol is a clinical protocol for the clinical study. The identifying can include identifying a second group of candidates in response to receiving a first query, the first query including at least one parameter characterizing the clinical study. The clinical protocol can be generated based on at least one of the following: the second group of candidates and an existing clinical protocol. The selected group of candidates can be selected from the second group of candidates. The parameter can include data describing at least one of the following: a medical condition, a pharmaceutical compound, a medical device, a patient population, and any combination thereof. Further, the parameter can include at least one of the following: demographic data, medical diagnosis, medical procedure, medications, laboratory test results, genomic sequence data, mutation data, variant data, biomarker data, and/or any combination there.

In some implementations, the method can include identifying at least one expert to assist the at least one principal investigator in conducting the study.

In some implementations, the identifying the second group of candidates can include retrieving at least one medical record associated with each candidate in the second group of candidates. The candidates in the selected group of candidates can be selected based on the retrieved at least one medical record. The medical record can include at least one of the following: anonymized data associated with at least one candidate in the second group of candidates and data identifying at least one candidate in the second group of candidates.

In some implementations, the site can include at least one of the following: a hospital, a clinic, a medical facility, a pharmaceutical company, a laboratory, and a medical office. The site can be identified based on at least one of the following: a distance between locations of candidates in the second group of candidates and a location of the site, a time when at least one candidate in the second group of candidates has requested and/or received medical services from the site, a type of medical condition being involved in the clinical study, age of at least one candidate in the second group of candidates, gender of at least one candidate in the second group of candidates, race of at least one candidate in the second group of candidates, and/or any other characteristics of at least one candidate in the second group of candidates, expertise of the site in a medical field, experience of the site in treating at least one medical condition, availability of particular medical equipment at the site, at least one treatment protocols implemented by the site, and any combination thereof.

In some implementations, the method can include communicating with a plurality of sites to establish a peer-to-peer network for jointly conducting the study, and establishing the peer-to-peer network of sites for conducting the study. The method can also include creating at least one filter for filtering access to data of at least one site in the peer-to-peer network, and preventing, based on the created at least one filter, at least one site in the peer-to-peer network from accessing data of at least another site in the peer-to-peer network. The method can further include identifying, for each site in the peer-to-peer network, at least one principal investigator associated with the site. The plurality of identified principal investigators can jointly conduct the study.

In some implementations, the method can include executing at least one additional query to reduce a number of candidates in the second group of candidates.

In some implementations, the current subject matter relates to a computer-implemented method for establishing a peer-to-peer network (e.g., for collaborative research, jointly conducting a clinical study, etc.). The method can include communicating with a plurality of sites to establish a peer-to-peer network, determining whether each site in the plurality of sites wishes to participate in the peer-to-peer network and selecting a first group of sites in the plurality of sites for participating in the peer-to-peer network, and connecting the first group of sites using the peer-to-peer network. At least one of the communicating, the determining and the connecting can be performed by at least one process of at least one computing system.

In some implementations, the current subject matter can include one or more of the following optional features. The method can also include creating at least one filter for filtering access to data of at least one site in the peer-to-peer network, and preventing, based on the created at least one filter, at least one site in the first group of sites from accessing data of at least another site in the first group of sites. The method can include identifying, for each site in the first group of sites, at least one principal investigator associated with the site. The plurality of identified principal investigators can jointly conduct at least one of the following: a clinical study, a research project, a collaborative project, a joint venture, and/or any combination thereof.

In some embodiments, the current subject matter can implement a tangibly embodied machine-readable medium embodying instructions that, when performed, cause one or more machines (e.g., computers, etc.) to result in operations described herein. Similarly, computer systems are also described that can include a processor and a memory coupled to the processor. The memory can include one or more programs that cause the processor to perform one or more of the operations described herein. Additionally, computer systems may include additional specialized processing units that are able to apply a single instruction to multiple data points in parallel. Such units include but are not limited to so-called “Graphics Processing Units (GPU).”

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE FIGURES

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary system 100 for identifying candidates for clinical trials, according to some implementation of the current subject matter;

FIG. 2 illustrates an exemplary method, according to some implementation of the current subject matter;

FIG. 3 illustrates another exemplary system for processing data, according to some implementations of the current subject matter;

FIG. 4 illustrates yet another exemplary system for processing data, according to some implementations of the current subject matter; and

FIG. 5 illustrates an exemplary process for identification of candidates for a clinical trial or a study, according to some implementations of the current subject matter;

FIG. 6 illustrates an exemplary process for performing a chart review, according to some implementations of the current subject matter;

FIG. 7 illustrates an exemplary system architecture for performing identification of patient candidates for clinical trials, according to some implementations of the current subject matter;

FIG. 8 illustrates an exemplary peer-to-peer network, according to some implementations of the current subject matter;

FIGS. 9a-9i illustrate various exemplary user interfaces that can be used to assist a user during any of the processes shown in FIG. 5, according to some implementations of the current subject matter;

FIGS. 10a-10b illustrate exemplary user interfaces that can assist the user in creating a peer-to-peer network shown in FIG. 8, according to some implementations of the current subject matter;

FIG. 11 illustrates an exemplary user interface that can allow a user to track queries that are being performed, according to some implementations of the current subject matter;

FIG. 12 illustrates an exemplary system, according to some implementations of the current subject matter;

FIG. 13 illustrates an exemplary method, according to some implementations of the current subject matter; and

FIG. 14 illustrates another exemplary method, according to some implementations of the current subject matter.

### DETAILED DESCRIPTION

In some implementations, the current subject matter relates to a method and a system for processing data. According to some implementations of the current subject matter, providers can be connected to a provider network, allowing access to statistical counts of patients from de-identified patient data. Researchers or other users can generate queries based on clinical study objectives and assumptions. The query can be submitted to the provider network. The queries can be based on, but are not limited to, inclusion/exclusion criteria, demographic data, etc. A search of a database(s) in the provider network can be conducted. The search can be performed locally or over a network of databases and can search de-identified patient data. The search can generate result(s), including various statistical analyses, where the results from various network sites and/or databases can be aggregated and provided to the user.

In general, over 70% of clinical trials fail to reach recruitment targets. This is primarily due to a combination of factors. Limited tools and access to patient data prevent data-driven trial design, validated trial sites and principal investigators (“PIs”) to lead the study are hard to find, and trial sites frequently overestimate the number of patients they are able to recruit.

Often, the design of a clinical study protocol (having the inclusion and exclusion criteria for the study participants) is not data-driven. Most study physicians at pharmaceutical and biotechnology companies that sponsor clinical trials rely on research and expert discussions, not patient data, to develop protocol criteria. Current real-world data sets can be expensive, may need to be ordered by the “slice,” and can incur significant time to order, receive, and ultimately review, and there can be no way to easily measure the impact of protocol changes on recruit-able patients or sites. Furthermore, there is currently no simple way to identify experts or key opinion leaders or providers at validated sites to support in-depth review of study protocols or the patient populations there are intended to target.

The selection of medical centers or healthcare providers that can act as clinical trial sites (herein referred to as “sites” or “providers”) is also not usually data-driven—it is generally based on anecdotal evidence of recruit-able patients which makes it difficult to identify principal investigators, who can lead the study at the site or to validate a site's estimate of how many patients they will be able to recruit for a given study.

The protocols for clinical trials are becoming increasingly complex, both in terms of patient criteria and the number and types of procedures that need to be performed. Studies currently can average 50 inclusion/exclusion criteria that must be satisfied for each candidate, up 60% from 2002. End points, procedures, and work effort at sites has all similarly increased. Such increased complexities, and the lack of internal tools to manage them, result in an increased number of protocol amendments—material changes to the study protocol which require resubmission for approval from the IRB. Currently, 59% of studies have at least 1 amendment; one-fifth of the changes in the amended protocols could be avoided with better candidate criteria (16% of the changes are in population description, 4% are in medical exclusions).

The added protocol complexities, and the need for often specialized patient populations, can make it difficult for sites to recruit patients when they use traditional recruitment tactics which are broadly distributed to local communities. Indeed, in a recent survey, sites reported they use no recruitment tactics at all in 32% of the studies analyzed, and in the studies where they used recruitment tactics, 45% of the time they reached out to prospective patient volunteers using traditional methods such as physician referrals, newspaper, and radio ads. Electronic medical record (“EMR”) databases (which contain the records of healthcare providers patient populations) were used only 6% of the time in study recruitment.

Using these traditional and untargeted methods for recruiting patients leads to difficulties in overall recruitment—11% of sites fail to enroll a single patient for a given study, and enrollment timelines must be extended 52% of the time for sites and the trial sponsors to try to meet their recruitment goals. These problems in recruitment can also lead to protocol amendments—9% of protocol amendments are initiated due to recruitment difficulty.

In some implementations, the current subject matter relates to a system for data processing and in particular, to a system for identifying candidates for clinical trials. As can be understood the current subject matter system is not limited to identification of candidates for clinical trials and can be used to identify individuals, group(s) of individuals, materials, data, and/or other objects based on a selection criterion/criteria. The current subject matter system can be, but is not limited to, implemented in any industry, including pharmaceutical industry, medical industry, research (e.g., medical, scientific, etc.) research industry, telecommunications industry, academia, etc. The following describes an exemplary implementation of the current subject matter system as it applies to identification of potential candidates for the purposes of conducting clinical trial(s) (e.g., for a drug, a medical device, etc.).

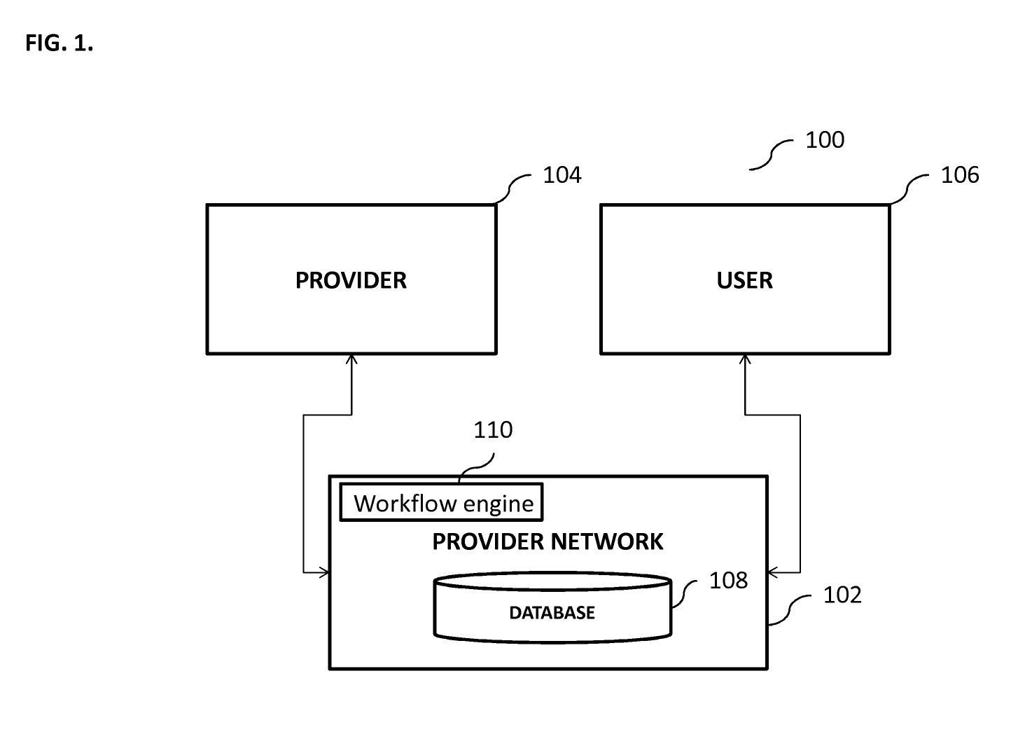

FIG. 1 illustrates an exemplary system 100 for identifying candidates for clinical trials, according to some implementations of the current subject matter. The system 100 can include a provider network 102 that can include one or more databases 108 and a workflow engine 110, one or more providers 104 and one or more users 106. The providers 104 can be hospitals, clinics, governmental agencies, private institutions, academic institutions, medical professionals, public companies, private companies, and/or any other individuals and/or entities and/or any combination thereof. The provider network 102 can be a network of computing devices, servers, databases, etc., which can be connected to one another via using various network communication capabilities (e.g., Internet, local area network (“LAN”), metropolitan area network (“MAN”), wide area network (“WAN”), and/or any other network, including wired and/or wireless). Some or all entities in the network 102 can have various processing capabilities that can allow users of the network 102 to query and obtain data related to the patients, where the data can be stored in one or more databases 108. The database 108 can include requisite hardware and/or software to store various data related to patients, where the data can be de-identified. The data can also contain various statistical counts of patients derived from the de-identified data.

The users 106 can be researchers and/or any other users, including but not limited to, hospitals, clinics, governmental agencies, private institutions, academic institutions, medical professionals, public companies, private companies, and/or any other individuals and/or entities and/or any combination thereof. In some implementations, the user(s) 106 can be a single individual and/or multiple individuals (and/or computing systems, software applications, business process applications, business objects, etc.). The user(s) 106 can be separate from the provider 104, such as being a part of a pharmaceutical company, and/or can be part of the provider 104 (e.g., an individual at a hospital, a research institution, etc.). Each such user 106 can be designing protocols for the study and/or analysis and/or research. The study can involve a new study, an existing study, and/or any combination thereof. It can be based on existing data, data to be obtained, projected data, expected data, a hypothesis, and/or any other data. The users 106 can query the data contained in one or more databases 108, where the query can relate to an identification of candidates for clinical trial(s). The queries can be written in and/or translated to any known computer language. The queries can be entered into a user interface displayed on a user's computer terminal. In some implementations, the data, e.g., patient data, can be stored locally in one or more databases of the data providers. In some implementations, the current subject matter can allow users and/or providers and/or any other third parties to generate a query in one language, format, etc., translate the query to the language, format, etc. of the location that contains the requested data, and generate an output to the issuer of the query. This can allow for a smooth interaction between users 106 and/or providers 104, i.e., the providers do not need to perform any kind of translation of user's queries into their own language, format, etc. In some implementations, the system 100 can be configured to store information about provider's data and how it is stored (e.g., location, language, format, structure, etc.) and how it should be queried. In some implementations, providers and/or users can submit to the system 100 their requirements and/or preferences as to how they wish queries of data should be submitted. This information can be provided manually and/or automatically by the users/providers. In some implementations, the system 100 can also contain a dictionary of terms that can be used to translate queries from one system (e.g., user system) to another (e.g., provider system) and vice versa. The dictionary can assist in resolving various discrepancies between terms that may be used by the users and/or providers. The above functionalities can be integrated into the network 102 and/or be part of the workflow engine 110. In some implementations, the results of the search (which can be related to that data, and is de-identified) can be stored centrally.

The system 100 and its network provider 102 can further include the workflow engine 110 that can be used to coordinate activities between providers and/or between pharmaceutical company and providers. The workflow engine 110 can also coordinate data requests, queries, data analysis, and/or output to ensure that the data requests are processed efficiently. For example, when a researcher at pharmaceutical company wants to initiate a chart review, the workflow engine 110 can manage coordination of the request to one or more data providers that can be performing the chart review, coordinating the responses, and returning the results back to the requester. In some exemplary implementations, connecting a researcher to a provider can also require multiple approvals within the provider organization before the researcher can execute the chart review.

The system 100 can be designed, for example, to allow clinical researchers at different organizations the ability to mine through significant amounts of clinical records and patient history for a number of different purposes. Researchers at pharmaceutical companies can use the system to improve clinical trial designs avoiding the possibility of having to amend the trial and losing valuable time and money in the effort to bring clinical trials to market. Hospital researchers can collaborate with other selected hospitals that are also part of the network 102 on certain diseases and treatment efficacy across a broad population of patients. Hospitals and providers can also use the system to search their own patient database. As can be understood, other users can also use the system to obtain requisite information.

The system 100, as opposed to conventional systems that include large patient datasets for research purposes, can include a federated model in which data can be stored and managed. To date, most approaches to collecting clinical research data requires the data to be stored in a single centralized database. That approach requires the copying of the clinical data, de-identifying the data, and normalizing the data into a single unified schema. While this approach allows for research to be performed, it requires significant governance policies to be put in place and the willingness of provider organization to allow their data to be copied and moved off-site. In addition, the data can become stale over time so constant data integration is needed.

The current subject matter system 100 can integrate a network of provider organizations where patient data never leaves the providers data center. Queries can be federated across providers in real time and only aggregated counts and other statistical characteristics of the results based on the query are returned to the user. A simple example can be a query for all people diagnosed with diabetes between the ages of 40 and 50. What is returned can be a count of the people that have that diagnosis and are between the ages of 40 and 50. A set of other statistics can be also returned (e.g., how many are male and how many are female, a more fine grained age breakdown, counts of the different medications patients are on, etc.).

The system 100 can be delivered as a web application to end users and can be cloud hosted. The system can be hosted on cloud hosted services and can include software that can be deployed behind the data provider firewalls. In some implementations, a secured and/or private network can be implemented, whereby access to the network and/or data contained therein can be restricted to members of the network. In some implementations, no special software and/or hardware and/or any combination thereof may be required behind a providers firewall. In some implementations, data providers can be hospitals, academic institutions, governmental agencies, public and/or private companies, clinics, medical providers, third party aggregators of clinical data, and/or any other individuals and/or entities.

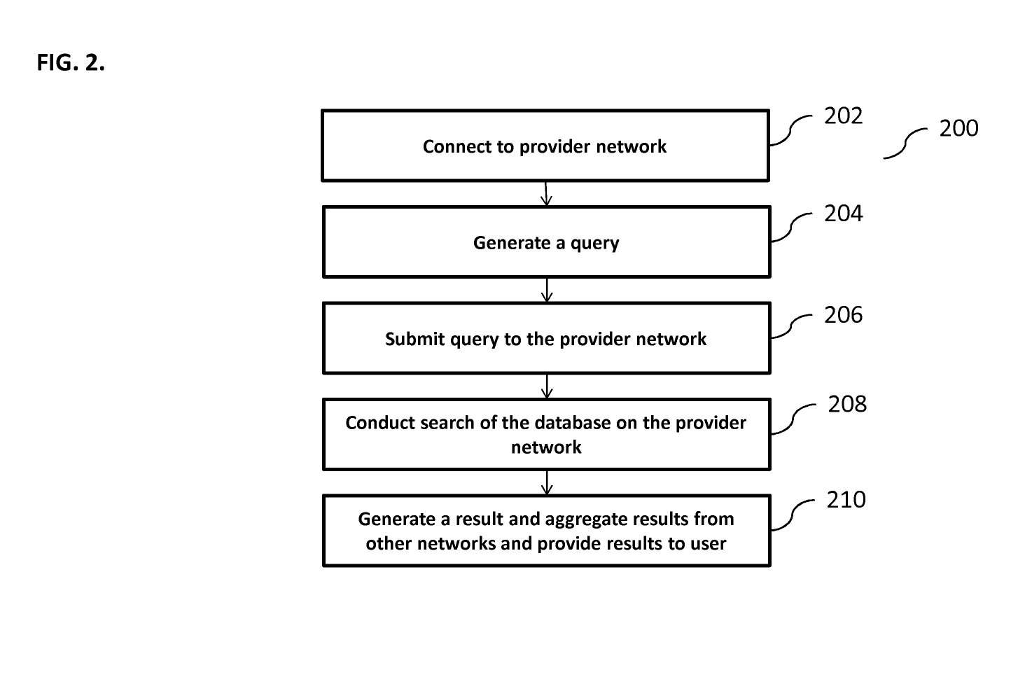

FIG. 2 illustrates an exemplary method 200, according to some implementations of the current subject matter. At 202, providers 104 can be connected to provider network 102, allowing access to statistical counts of patients from de-identified patient data. At 204, researchers or users 106 can generate queries based on clinical study objectives and assumptions. The query can be submitted to the network 102, at 206. The queries can be based on, but are not limited to, inclusion/exclusion criteria, demographic data, etc. A search of the database(s) 108 can be conducted, at 208. The search can be performed locally or over a network of databases and can search de-identified patient data. The search can generate a result, including various statistical analyses, at 210, where the results from various network sites and/or databases can be aggregated and provided to the user 106.

In some implementations, researchers can reach back to selected network sites to collaborate on patient recruitment feasibility, trial design, and site selection.

In some implementations, some exemplary users 106 can include individuals and/or entities at biotech and pharmaceutical organizations that can make use of the resulting data for research and workflow coordination with healthcare organizations in support of clinical trial design and execution. In some implementations, biotech and pharmaceutical company users can never have access to de-identified or identified patient data, and they can only have access to statistical information (counts) about a patient population across providers.

In some implementations, some exemplary users 106 can include researchers/investigators at provider organizations that are interested in initiating their own research, or collaborating with company users in a workflow activity. These users can have access to de-identified and/or identified patient data depending on the nature of the policies enforced by the individual provider. As can be understood, other users and/or groups of users can have various access to the data.

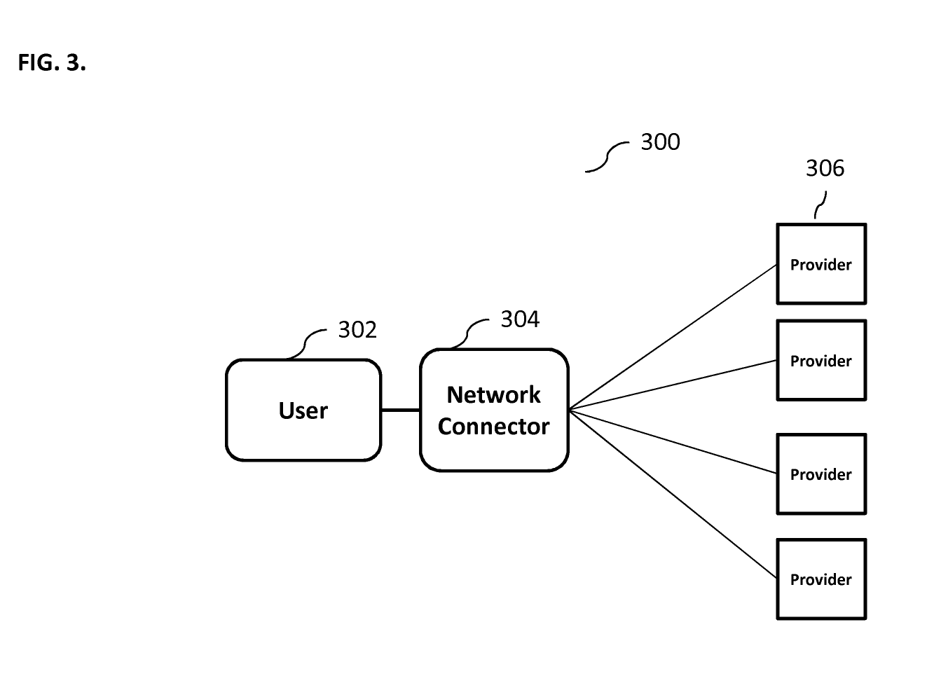

FIG. 3 illustrates another exemplary system 300 for processing data, according to some implementations of the current subject matter. The system 300 can include a network connector 304 that can be communicatively coupled to a data user 302 (similar to a user 106 shown in FIG. 1) and that can be communicatively coupled to at least one data provider 304 (e.g., a data provider can be a hospital, a medical clinic, a medical professional, and/or any other entity). The network connector 304 can be configured to receive data from the provider 306, the user 302 and/or both. The user 302 can be configured to generate a query and forward it to the network connector 304 for processing. The network connector 304 can be further configured to perform processing of the query and obtain data responsive to the query. The response can be provided to the user 302 (e.g., a pharmaceutical company, and/or any other entity requesting data). The network connector can include components and/or perform functions discussed above with regard to FIGS. 1 and 2.

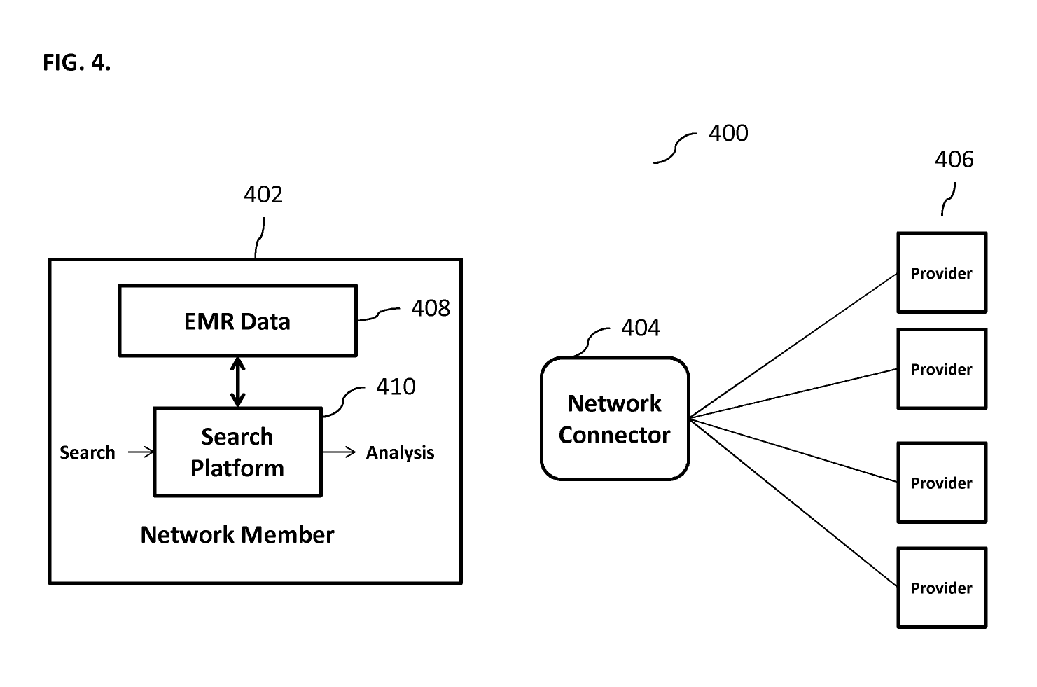

FIG. 4 illustrates another exemplary system 400 for processing data, according to some implementations of the current subject matter. The system 400 can include a network connector 404 (similar to the network connector 302 shown in FIG. 3). The network connector 404 can be configured to be communicatively coupled to at least one data provider 406 (similar to data providers 306 shown in FIG. 3). A network member 402 can be configured to communicate with and/or be part of the network connector 404. The network member 402 can include a search platform that can be used for searching of data and/or providing analysis of data and generating output. In some implementations, the data can be EMR data. As can be understood, the data can be any type of data (e.g., medical, scientific, research, etc.).

In some implementations, the current subject matter system (e.g., a system shown in FIG. 1) can support various activities in connection with selection of candidates for a clinical study. These can include at least one of the following: exploratory research and clinical trial design, determination/selection of a site where to conduct a clinical study, determination/selection of a principal investigator (“PI”), determination/selection of patient candidates, as well as any other activities. The current subject matter system can provide users and providers with an ability to query various data (e.g., patient data (which can be anonymized, de-identified, and/or identified, etc.), site data, scientific data, medical data, and/or any other data), analyze the queried data, generate reports, and/or perform any other activities that may be associated with conducting a clinical study.

In some implementations, users can also access the current subject matter system to perform clinical trial protocol design and/or site determination/selection. The users can also collaborate with providers (where provider can, for example, supply various data, patient candidates' data, etc.) on a clinical study. The providers can use the current subject matter system for the same set of use cases to facilitate investigator led research and/or to stimulate both industry- and/or investigator-sponsored clinical research.

In some implementations, the current subject matter can also support exploratory research, which can allow users to ascertain population of patient candidates, including various attributes of the patients in the population (e.g., medical conditions, age, location, relationship to the provider, etc.). For example, when considering a study for diabetic patients, a study physician can identify a cohort of patients with a diabetes diagnosis, and then explore a range of medications, laboratories, co-morbidities, procedures, and/or any other characteristics of the cohort.

The current subject matter can also support study feasibility and cohort segmentation. In this case, when a clinical study is being developed, a user can query various data to measure an impact of specific inclusion and/or exclusion criteria for the study on cohort size. Predetermined criteria can be inputted directly into the query, and additional criteria can be realized and considered while exploring the characteristics of the patient cohort. Search results can be saved, and different versions of queries for a study can be compared (either overlaid or show a side-by-side) to demonstrate how changes in query criteria affect the cohort populations.

Further, the current subject matter can be used to perform preparatory chart review procedure. This procedure can allow a user can initiate a request to the provider, asking the provider to review medical history of patient candidates. In some cases, especially when the criteria are complex and/or there are a limited number of patients available, the user can conduct a deeper review of patient candidates' medical records (electronic and/or paper) to further understand representative patient population for the study.

In some implementations, the current subject matter can be used to perform identification of an expert for the purposes of protocol review. In some cases, the user can consult with expert(s) and/or key opinion leader(s) (“KOLs”) as part of a protocol review process. The current subject matter can identify such experts and/or key opinion leaders based on the information about patient candidates, site of the study, and/or any other factors.

As stated above, the current subject matter can also perform determination/selection of a site for the study. To improve the likelihood of a successful trial, the user can determine/select sites (e.g., hospitals, clinics, etc.) where there is a significant number of patient candidates that meet various criteria (e.g., inclusion/exclusion criteria) documented in the study protocol. In some implementations, the current subject matter can provide patient candidates' counts down by site, providing insight into which providers can be used as study sites.

Further, the current subject matter can perform identification/selection of a principal investigator for the clinical study at a site. In some implementations, once clinical study sites have been identified/selected and principal investigator has been identified/selected, patient candidates identification/selection and/or recruitment for the study can be performed. This can be accomplished using databases containing information about patient associated with the identified/selected sites, new patients that come to the site for medical advice and/or treatment, etc. The current subject matter can also perform monitoring of new and/or existing patients that come to the site for medical advice/treatment to determine whether or not they meet criteria identified for the study. The criteria can include, but is not limited, to age, gender, location, type of disease, family history, type of medical condition for which advice/treatment is being sought, as well as any other criteria.

In some implementations, patient identification/selection and/or recruitment for the study can be based on a predictive analysis of parameters of the study and/or its protocol. For example, the current subject matter can determine that a particular patient may not be a good candidate for the study in view of the patient′ geographical location being too distant from the site where the study is going to be conducted. Alternatively, it can be determined that patient's seldom visits to the site, where the study is going to be conducted, may disqualify the patient from being a good candidate. However, patient's unique medical condition, recent diagnosis, etc. may make the patient a good candidate for the study regardless of the patient's geographical location, number of visits to the site, etc. In some implementations, such predictive analytics can be also used to determine a site for conducting of the study. The current subject matter can be used to determine whether a site is a good candidate for the study based on a location of patients, medical conditions of the patients, expertise of the site in a particular field, availability of a particular principal investigator, etc.

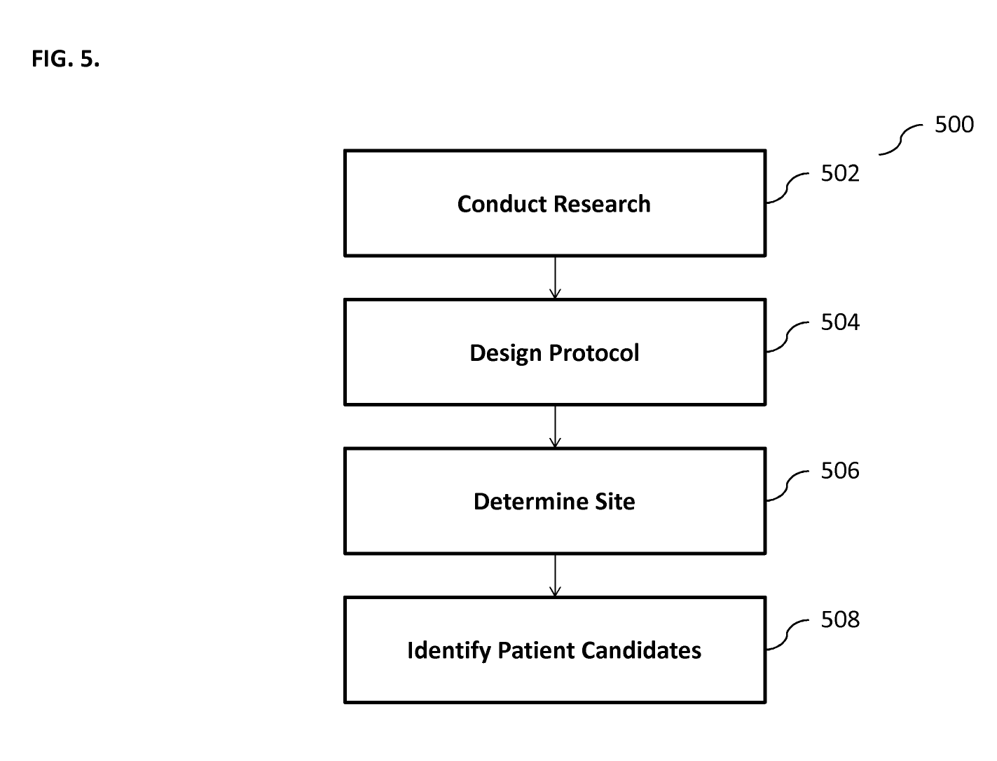

FIG. 5 illustrates an exemplary process 500 for identification of candidates for a clinical trial or a study, according to some implementations of the current subject matter. The process 500 can be performed using the system 100 shown in FIG. 1. At 502, a research relating to the study can be conducted, which can include gathering information about the study (e.g., its parameters, inclusion/exclusion criteria, sites information, etc.). At 504, a protocol for the clinical study can be designed. At 506, a site identification/selection can be performed. At 508, identification/selection can be performed. The process 500 can be used to integrate a network of provider organizations where patient data never leaves the provider's data center. Queries, performed as part of the process 500 can be federated across providers in real-time and aggregated counts based on the query criteria can be returned to the user along with other valuable statistics about the selected population, including demographics, diagnoses, medications, procedures, lab results, etc. Additional workflow tools can facilitate protocol criteria refinement, site and PI identification and selection, patient identification and recruitment, as well as any other functions.

The research, at 502, can include performing analysis of a cohort of patient candidates for the study. In connection with performing analysis of a cohort of patient candidates, the patients meeting various criteria can be identified. To identify the patients, the user can issue a query that can perform a search using various inclusion and/or exclusion parameters that can relate to clinical data including for example, but not limited to, demographic data, diagnoses, procedures, vital statistics such as blood pressure and weight, medications, lab test results and/or values, genomic sequence, mutations, variants, biomarkers, gene and/or protein expression levels, and/or any other information. In some implementations, the user can begin with broad criteria search and then narrow the criteria as the user understands characteristics of patients meeting the criteria entered by the user. The user-generated query can be submitted to all providers that can be connected to the network (e.g., network 102 shown in FIG. 1). In return, the providers can return patients (e.g., including number of patients) that can meet the criteria in the query. In some implementations, for the patients meeting the query criteria, additional clinical data can be returned, which can include, but is not limited to: a geographical map showing patient distribution across providers, an indication of a distance of the patients' locations from the provider location, an indication of a breakdown of the patients ages and/or genders (and/or any other criteria), a histogram showing a number of patients with additional diagnoses (e.g., comorbidities, etc.), a histogram showing all medications prescribed for each patient and/or all patients, a histogram showing all procedures performed for each patient and/or all patients, a histogram showing all lab types and/or the distribution of all lab results for each lab type for each patient and/or all patients. This data can assist the user in understanding patient population and/or in potentially uncovering other patient characteristics that can be considered in the study's inclusion and/or exclusion criteria.

In some implementations, the data responsive to the query can be represented in a user-friendly, intuitive way. In some implementations, the data can be encoded, such as, by using standard clinical coding schemes like ICD-9, ICD-10, and/or any other type of coding for diagnosis, LOINC codes for lab tests and results, CPT codes for procedures, and RxNorm (or in some cases SNOMED) for medications. As can be understood, any other ways of coding the data responsive to the query can be used. Users performing a query do not need to know the specific codes, although if they are known, they can be used to find the correct term. In some implementations, the current subject matter can include an auto-complete feature that can allow the user to begin typing any term and the system can list similar terms based on heuristic matching logic to speed the use of the system and make it simple to specify the requisite criteria. For each term, the user can see how many patients have that specific diagnosis, lab, procedure, medication prescription, etc. across the entire network of millions of accessible de-identified patient records.

In some implementations, queries performed by the user and/or their results can be stored and identified as being related to the study that the user desires to conduct. The information can be stored in a database and/or any other memory location. The queries and corresponding results can be compared based on various parameters, e.g., identified patients, medical conditions, locations, etc. In some implementations, the results of the queries and/or the studies can be shared with third parties and can be used to track various activities relating to the studies.

In some implementations, as part of the protocol design, at 504, a preparatory chart review process can be performed. The chart review process can allow the user to issue a request to providers to review patients' medical record(s) that relate to the study criteria. This can allow the study criteria to be further scrutinized by comparing the study criteria with actual patient records. It can further facilitate better connections between study physicians at a pharmaceutical company and principal investigator to further refine protocol criteria and/or improve the trial design, as well as it can increase the likelihood that a particular provider institution will become a site for conducting the trial study.

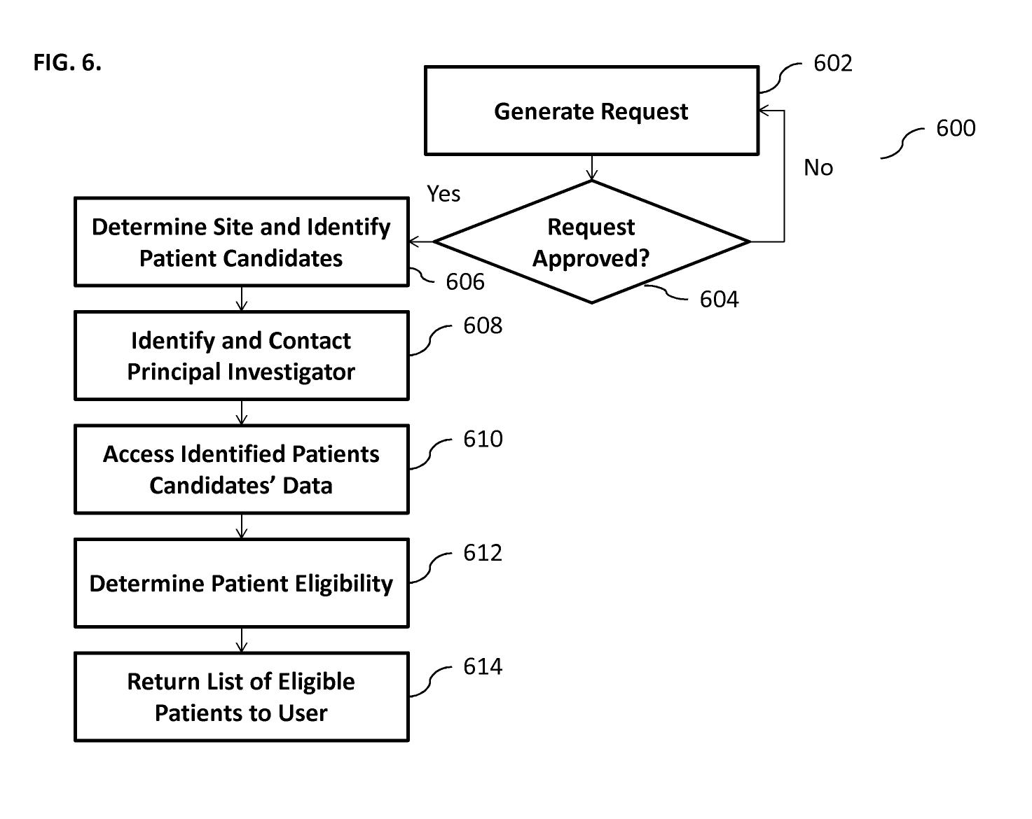

FIG. 6 illustrates an exemplary process 600 for performing a chart review, according to some implementations of the current subject matter. The request for a chart review can be initiated, at 602, by the user during, after, and/or before performing of a query (whether first query and/or any subsequent query). The chart review request can be tied to the query and can be used by provider(s) to identify the patients that meet one or more criteria specified in the query. When requesting a chart review, the user can include a concept sheet that can provide a non-confidential summary of the study and a description of the request. A non-confidential version can allow a recipient of the request to make an informed decision to perform the chart review and/or not prior to being bound by a confidentiality agreement.

The generated request can then sent to the user's management team for review, and once the request is either approved and/or denied, at 604, the user's study physician can be appropriately notified. The current subject matter system can provide a status of the generated request to the user. If the request is denied, the process returns to 602 and a new request can be generated.

If the request is approved, the sites (and/or any individual(s)) to which a request can be submitted to can be determined and/or identified, at 606. Additionally, patient candidates at the sites can be identified. In some implementations, providers can determine how they would like to be contacted for a chart review request and their contact policies can be configured into the system. In some implementations, a confidentiality agreement and/or any other relevant documents and/or messages that need to be presented to the site can be also submitted to the sites. Different sites can have different documents and/or messages sent to them. Once the request is sent to the providers, it can be tracked.

At 608, a research coordinator, study nurse, a principal investigator, and/or any other individual at each identified/selected site, can be identified and contacted for the purposes of receiving information describing purpose of reviewing the generated request and/or accepting/denying the terms of the generated request. The site's PI and/or individual performing the chart review can be asked to confirm that they have the authority to view Protected Health Information (PHI) and that the institutional review board (“IRB”) authorizes them to access this data for this purpose. If the individual declines the confirmation process, the user can receive an appropriate notification of the decline.

Once the individual agrees to access patient information, the individual can be presented with a list of identifiable patients at the site that meet the criteria included in the query, at 610. The individual can use this information to review patients' records and then determine whether a particular patient is a likely and/or an unlikely candidate for the trial, at 612. When the review of the identified patients is completed, the results of the review can be submitted to the user, at 614. The results can include, but are not limited to: a count of patients reviewed, counts of likely and/or unlikely patients, and/or any other information related to the patients' records that were reviewed.

In some implementations, the returned results can be stored in a database and/or any other memory location associated with the user. The results can be used to refine the study criteria. Further, the ratio of patients that can be selected for the study can be used for protocol design, site selection, etc. as it can allow for better sites selection, determination of a number of sites that may need to be recruited to perform the study. For example, knowing that it is likely that only 50% of the possible patients are eligible means that more sites can be recruited sooner rather than waiting to see the results of trial site recruitment.

Referring back to FIG. 5, as part of the protocol design, at 504, a peer review process can be performed. Peer review process can assist the user (and/or its study physician(s)) by connecting the user with key opinion leaders (“KOLs”) in a certain field, the doctors that see patients matching query criteria (and/or study criteria). When the user performs a query, they can access information about the physicians (e.g., identity, practice field, location, affiliation, publications, etc.) that are and/or have treated those patients.

In some implementations, when the user performs a query, the user can also request to perform a peer review process. Once this process is requested, the user can access to at least one of the following: information about each provider with patients matching search criteria and that are and/or have treated those patients (information can be sorted by patients, medical conditions, outcomes, physician's specialty relative to the criteria, etc.), provider organization's contact information, and a list of key opinion leaders and/or experts relative to the study. The provider can elect to restrict provider's identity and/or require permission to access this information. If permission is granted to view the provider information, then the permission can be applicable only to the specific study and for the specific study physician (or the user) making the request.

Once the protocol design, at 504, is completed, an identification/selection of the site to conduct a study can be initiated, at 506, as shown in FIG. 5. A site can be a hospital, a clinic, a laboratory, any other medical facility and/or any other facility. In some implementations, a clinical study can be conducted across multiple locations and thus, several sites can be identified and/or selected for the purposes of conducting a study. The selection criteria can be same, similar, and/or different for each site that is to participate in the study. In some implementations, the user can determine a list of preferable sites that the user wishes to be participants in the study and submit appropriate requests to the sites. Each site upon being selected can accept and/or reject user's request to participate in the study and if accepted, provide appropriate information to the user.

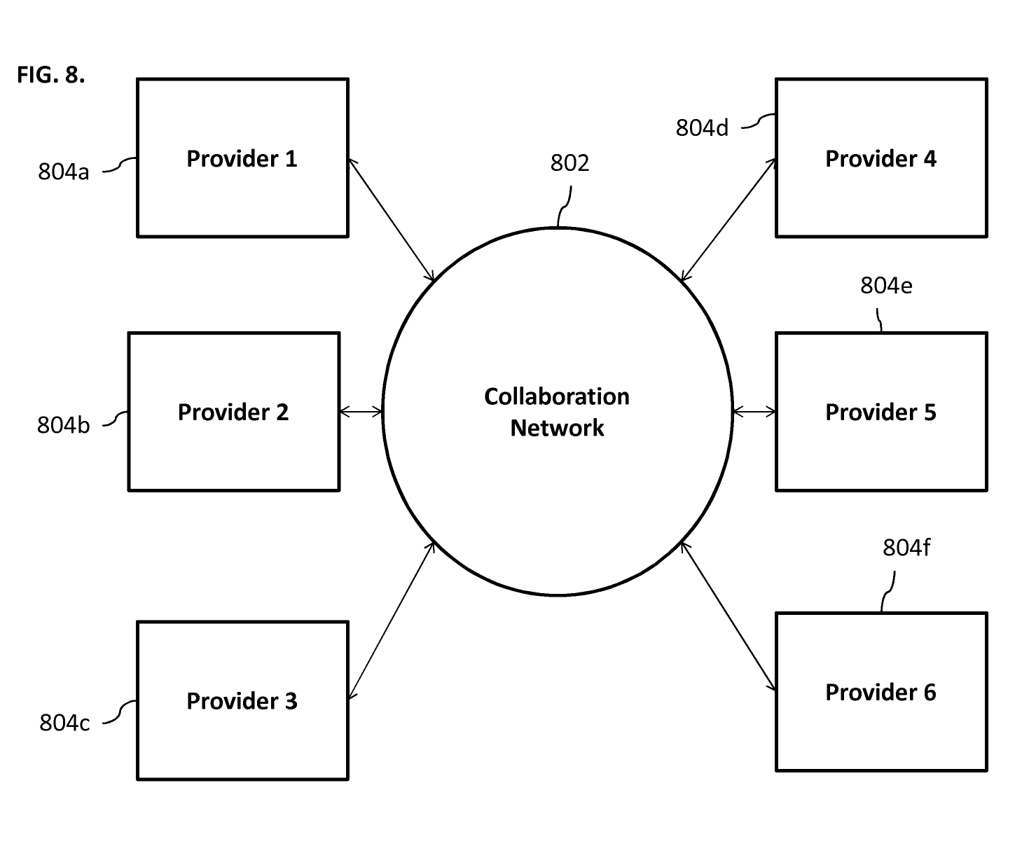

Once the sites are selected, the current subject matter can provide a collaborative network 802, which can connect provider sites 804 (a, b, c, d, e, f), as shown in FIG. 8. In some implementations, the collaborative network 802 can be setup for the purposes of the study and/or for any other reason that may and/or may not be related to the study (e.g., providers (e.g., hospitals, research institutions, clinics, educational institutions, pharmaceutical companies, etc.) can be working together on various joint projects whether or not related to the medical field). The collaborative network 802 can include one or more servers that can connect the sites 804 via any type of network (e.g., MAN, WAN, Internet, intranet, extranet, wireless network, etc.). In some implementations, multiple network channels can be implemented on the same system to create multiple disparate research networks and can be used to form the collaborative network 802. In some implementations, if multiple sites 804 are participating in the study, the sites 804 can also collaborate with one another through sharing of information, which can include patient information, clinical techniques, results of procedures, various site operational policies and procedures, expertise in a particular medical field, etc. Further, the sites 804 can also share their personnel upon appropriate request. In some implementations, the selected sites 804 (which may or may not ultimately participate in the study) can restrict access to their information by other sites. The collaboration network 802 can receive sites' 804 restrictions and create filtering mechanisms that can limit access to sites information based on a specific purpose (e.g., related to a particular disease, patient cohort, data, etc.) creating a virtual data mart. Thus, when a site (and/or a user 102 shown in FIG. 1) submits a query to one or more sites, the results of the query can be filtered based on the site-specific filters that are requested by each site and implemented by the network 802. This can prevent sites from accessing confidential and/or sensitive data and/or information of other sites that may be competitors.

The filtering mechanisms can be software, hardware, and/or a combination of both that can be design to detect a query that has been generated as well as results that may have been received, compare the query and/or the results to at least one parameter set in the filtering mechanism, and prevent forwarding of data to originator of the query. In some implementations, the collaboration network 802 can automatically filter a query from a query source (e.g., another site and/or a user) before submitting the query to a target site (e.g., a site 804) and indicate to the query source that information requested by the query source is not available and/or access to such information has been restricted by the target. In some implementations, network 802 can submit the query from the query source to the target site and receive data that may be responsive to the query (in some implementations, the target site can have its own filters that can filter and/or prevent submission of data from the site to the network 802) and filter the data in accordance with the filtering parameters that have been identified by the site and implemented in the network 802. The network 802 can keep track of all filters that can be requested by the sites 804 and apply them appropriately based on the queries received from a query source.

Referring back to FIG. 5, site(s) identification/selection process, at 506, can be automatic and/or manual. The current subject matter can identify/select site(s) based on various parameters, which can include, but are not limited to, at least one of the following: distance potential patient candidates' location to the providers' locations, timing of when potential patient candidates have requested and/or received provider's medical services, type of medical condition being involved in the study, age, gender, race, and/or any other characteristics of potential patient candidates, expertise of the provider in a particular medical field, experience of the provider in treating a particular medical condition, availability of particular medical equipment at the provider's location, treatment protocols implemented by the provider, and/or any other data (such as data available from http://www.clinicaltrials.gov), as well as any other factors and/or any combination of factors.

In some implementations, the site(s) identification/selection process can be initiated using the query generated by the user that is related to the study and/or a separate query that is specifically related to the identification/selection of provider site(s). The query can result in identification of provider sites that can be already part of the provider network 102 (shown in FIG. 1) or “on-network” sites, and/or sites that are not yet part of the provider network 102 or “off-network” sites. The query results can list “on-network” sites first. Some “on-network” sites can have a preferred status and can be identified at the top of the list. The provider site list resulting from the query can be sorted by the highest number of recruitable patients, history of working with that site, particular medical conditions being treated, expertise of the site in a specific medical field and/or any other field, availability of physicians and/or specialists, number of trials the site currently has underway, and/or any other factors and/or any combination of factors.

Once the sites are selected, the user can initiate site recruitment process, which can include sending an electronic customizable site survey to the site which can request a variety of information about the site and/or its patients, medical professionals, procedures and policies, equipment, etc. This can be a workflow process performed by the workflow engine 110 (shown in FIG. 1), which can track and store all responses and/or lack thereof, as well as send follow-up requests, and/or reminders. The original queries can also be modified and/or changed in any way to address the needs of the study.

In some implementations, after the “on-network” sites are listed in response to the query, the “off-network” sites can be also listed. These sites can be identified as possible locations based on past history working with the sites, and/or having participated in similar clinical studies and/or through possible partnerships with site identification and/or activation vendors. This can allow the user to select any sites that may be suitable to conduct the clinical study.

In connection with identification/selection of the site, the current subject matter can also identify/select a principal investigator or investigators who will conduct the clinical study. The investigator(s) can be identified using a query that has been originally issued by the user (at 502-504 shown in FIG. 5) when the study is requested, when the site identification/selection process is performed, and/or using a separate query. The investigator(s) can be identified using one or more of the following exemplary factors (which are not limiting or exclusive). One of the factors relates to the providers that have been identified/selected, at 506, the provider list can be culled to focus on providers that may have expertise in specific areas that may relate to one or more parameters of the user's query. The providers can be based on a specific patient cohort that has been identified. Further, the investigator(s) can be identified based on information related to each site provides' research staff (as can be filtered using the query parameters). Alternatively, the investigator(s) can be selected based on user's preferences and/or recommendations of third parties. The investigator(s) can be identified at the time the user initiates the research, at 502.

Once the site(s) and principal investigator(s) are identified/selected, patients can be identified/selected and/or recruited, at 508, as shown in FIG. 5. In some implementations, a separate query can be issued to query the data related to the cohort of patients that has been identified during processes 502-506 shown in FIG. 5. The query can limit the number of patients that may eventually participate in the study. The identified/selected principal investigator(s) can also be required to enter appropriate authentication and/or authorization information (e.g., an IRB information) indicating that the principal investigator(s) is appropriately authorized to view patients' medical records and/or any other information. Once this is complete, the principal investigator(s) can be presented with a list of identified patients, including the patient's primary care provider(s). This list can be used to track the patients that have been recruited and those that have been determined not be suitable for the study. The current subject matter can also track patient recruitment process through various tracking mechanisms. Once a patient has been selected and agreed to participate in the study, the patient's record can be flagged in the event the patient receives other healthcare services and/or has a medical emergency.

In some implementations, to identify potential candidates for a study, at least one of the following exemplary, non-limiting, data can be used: existing patient medical histories, data related to proactive monitoring of patients (which, for example may be needed in view of the nature of the trial's enrollment criteria (e.g., a newly diagnosed diabetic patients that have not yet been prescribed a medication, newly pregnant women for trials that require a specific gestational range like 20-24 weeks), as well as any other parameters.

In some implementations, to ensure that the principal investigator(s) is provided with an up-to-date information on the selected patients as well as other patients that can be eligible to participate in the clinical study, the current subject matter can allow re-running of the patient queries automatically, periodically (e.g., weekly, semi-weekly, monthly, and/or based on any other period, etc.), and/or manually. The patient list can be updated when a new candidate patient is identified that meets the criteria of the query. This new candidate can be highlighted on the list and the principal investigator(s) can receive a notification when the list has been updated. Further, the current subject matter can perform monitoring of lab results, prescription orders, and/or any other information in order to identify newly eligible candidates. Once the patient is flagged the patient can also appear on the patient recruitment list. The user can set up the study for active patient monitoring and can specify any criteria that should be monitored.

As discussed above with regard to FIG. 8, the collaborative network 802 can be setup among a plurality of providers 804. Using the network 802, a principal investigator(s) can use the above techniques to identify a cohort of patients and/or to refine study protocol criteria in view of the multiple provider participants. Further, as stated above, as part of the collaborative network 802, providers 804 can be prevented from accessing data of other providers 804 unless specific permission has been granted for this collaboration. Providers 804 can also be prevented from having an open access to the network 802.

Using the collaborative network 802, patient cohort analysis can be performed within a specific provider 804 using its own de-identified data (which can be in accordance with that specific provider's policies). In some implementations, the current subject matter system can require providers 804 to execute and/or subscribe to a collaboration and/or confidentiality agreement(s) prior to conducting research and/or analysis of data across multiple providers 804. As stated above, the agreements may limit the research and analysis to a specific area (e.g., medical condition, a drug, types of patients, etc.). Collaboration among providers 804 can be constrained to a specific “study context” which can be represented by items in an ontology tree and/or any other demographic constraints.

In some implementations, at least one provider 804 can be selected as the provider that will be leading the study and the remaining providers in the network 802 can be designated as sponsoring providers. In some implementations, the network 802 can operate using informatics for integrating biology and the bedside (“i2b2”), which can be a tool for organizing and analyzing clinical data. Using the i2b2 tool, a principal investigator at one site can initiate creation of a network of providers, which can assist researchers, other investigators, and/or other users in performing queries. The network can be setup for a limited purpose and/or constrained to specific areas (e.g., medical conditions, pharmaceutics, drugs, etc.). Any queries that can be issued by the users of the network can be (automatically and/or manually) limited to the purposes for which the network was setup. The providers in the network 802 can chose to exit from the collaboration agreement and the network 802. Alternatively, providers can be removed from the network 802. New providers 804 can also join the network 802 provided they meet appropriate criteria and subscribe to the collaboration/confidentiality agreements. New providers 804 can join on their own and/or at the request of the principal investigator(s) and/or other providers 804. The principal investigator(s) working with the providers 804 in the network 802 can also request that other principal investigator(s) associated with the providers 804 PIs join the principal investigator(s) in the collaboration. These other principal investigator(s) may have been previously identified through other professional collaborations. If principal investigator(s) is associated with multiple providers, then a specific provider can be selected to ensure that the principal investigator(s) is performing this study on that provider's behalf.

In some implementations, the current subject matter system can be accessed and/or allow access by a plurality of entities (e.g., individuals, computing entities, business processes, business objects, business applications, etc.). The current subject matter system can include an administrator that can monitor operation of the current subject matter system and its associated networks. The administrator can also coordinate software updates, if any. An auditor of the current subject matter system can also monitor user activity, including issues, anomalies, viruses, etc.

At the provider (e.g., provider 104 shown in FIG. 1), various individuals can access the current subject matter system. These can include a principal investigator(s), a study nurse, a trial coordinator, an informacist, and a provider administrator. The principal investigator(s) can be responsible for the clinical trial and ensuring patient safety. The principal investigator(s) can also perform the chart review process discussed above. The study nurse can work with principal investigator(s) to coordinate the trial with patients, including, but limited to, recruitment, monitoring patients through trial, etc. The study nurse can also perform the chart review process along with principal investigator(s). The trial coordinator can work with provider's clinical trial office and can coordinate activities with new and ongoing trials. The trial coordinator can also receive trial surveys and chart review requests. The informacist can configure and manage ontology and coordinate data mapping and quality issues. The provider's administrator can manage user accounts and local software setup at the provider.

The user (e.g., user 106 shown in FIG. 1) can include a study physician and a study manager. The study physician can be responsible for developing the study protocol and can assess and/or refine viability of the trial criteria. The study manager can be responsible for identifying and recruiting clinical trial sites and can coordinate chart review requests initiated by the study physician.

In some implementations, the current subject matter can provide at least one of the following functionalities: query building, result reporting, provider collaboration, data quality and ontology tools, administration tools, development infrastructure, preparatory chart review, site identification/selection, peer review, patient recruitment, as well as other functions.

In some implementations, the query building functionality can include at least one of the following: auto completion of query terms, providing a number of patients that match each query term, applying parameters to query terms when applicable, specifying a date range for any query term, applying Boolean logic to the query terms, automatic tracking of query history, and/or any other functionalities. The results reporting functionality can include at least one of the following, providing a number of patients matching the query criteria, providing age and gender breakdown, providing patient counts by provider, providing patient diagnosis/comorbidities, providing patient laboratory results and/or values, listing patient medications and/or procedures, and/or any other functionalities. The provider collaboration functionality can include at least one of the following: creation of a network of providers, constraining search criteria to a field of study, tracking activity of providers, grouping membership workflow processes, and/or any other functionalities. The data quality and ontology tools can include at least one of the following: tools to develop and/or manage master ontology, mappings to master ontology, providing information about anomalies and/or inconsistencies, testing query harness for on-boarding provider to verify performance, etc. The administrative tools can include at least one of the following: provider and user management, provider setup and configuration, system monitoring, infrastructure notifications upon occurrence of application and/or system errors, audit log access and/or review, etc. The development infrastructure functionalities can include at least one of the following: development tools and infrastructure, defect tracking, development and test environments, automated build and regression testing, source code management, etc.

In some implementations, the preparatory chart review functionality can include at least one of the following: requesting and tracking a chart review, coordinating the chart review with provider sites, generating provider access lists of identified patients that meet the query criteria, streamlining acceptance process with click-through agreements, tracking and consolidating results, consolidating results and applying results to site recruitment recommendations, etc. The site recruitment functionality can encompass at least one of the following: recommending list of on-network sites, recommending list of off-network sites, performing user-specific site experience tracking, providing access to site contacts and principal investigator(s), automating site survey process, re-use of query at on-network sites, and others. The peer review functionality can include at least one of the following: providing access to contact information of principal investigator(s) with patients, providing access to identities of experts and/or key opinion leaders, and others. The patient recruitment functionality can include at least one of the following: re-use user query, if possible, generating queries to patient cohort, tracking patients screened and/or enrolled in the study, monitoring for new eligible patients

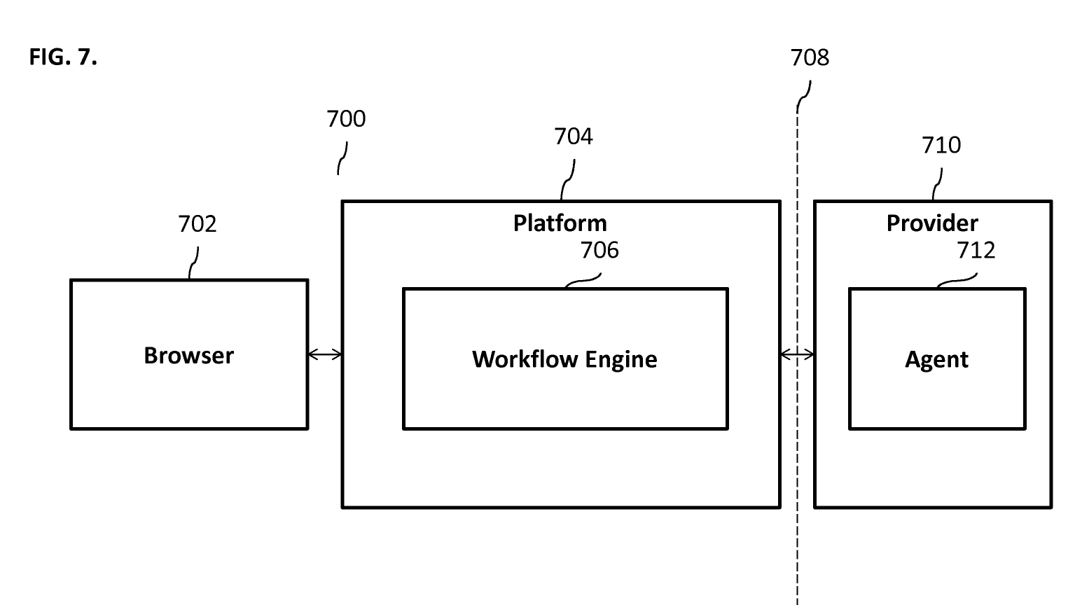

FIG. 7 illustrates an exemplary system architecture 700 for performing identification of patient candidates for clinical trials, according to some implementations of the current subject matter. The system can include a browser component 702, a platform component 704 that can include a workflow engine 706, a firewall component 708, and a provider component 710. The browser component 702 can be used by the user 106 (as shown in FIG. 1) to generate queries, design study protocol, access various data, and/or perform any other functionalities discussed above. The platform component 704 can be software, hardware, and/or any combination thereof and can be included in the provider network component 102 (as shown in FIG. 1), where the workflow engine 706 can be similar to the workflow engine 110 (as shown in FIG. 1). The platform can be a software-as-a-service (“SaaS”) platform where entities using the platform can manage their own users, their own access controls, and/or control their own configuration. The provider 710 can include a platform agent 712 that can provide access for the provider to the platform 704 and the user 702 and vice versa. The agent 712 can be a software, a hardware, and/or any combination thereof. In some implementations, the agent 712 can be installed on the provider system. Alternatively, the agent 712 is not used and the provider can directly access the platform 704.

The firewall 708 can provide appropriate security to the data being exchanged between the provider 710, the user 702, and the platform 704. In some implementations, to enhance security of the data being exchanged and/or accessed by the platform 704, the agent 712 installed on the provider system can communicate with the platform 704 without requiring any listening communication ports to be open. In some implementations, any patient data, identified and/or de-identified, may never leave the provider's data center and/or control unless specific authorization to access that information is received and/or granted. All access to patient data and/or platform 704 can require secure authentication and all activity can be audited.

In some implementations, the platform 704 can be a combination of an enterprise application and a cloud hosted multi-tenant SaaS application. The cloud-hosted SaaS infrastructure can provide core management and/or administration services, web application for clinical research, and/or can manage workflow activities for coordination of various workflow activities. In some implementations, the platform 704 can also include a database (e.g., database 108 shown in FIG. 1) that can be a cloud hosted instance of a relational database. This database can store queries, query results, user identities, configuration information, master ontology, data mappings, metadata, etc. This database can be automatically replicated and backed up for high availability.

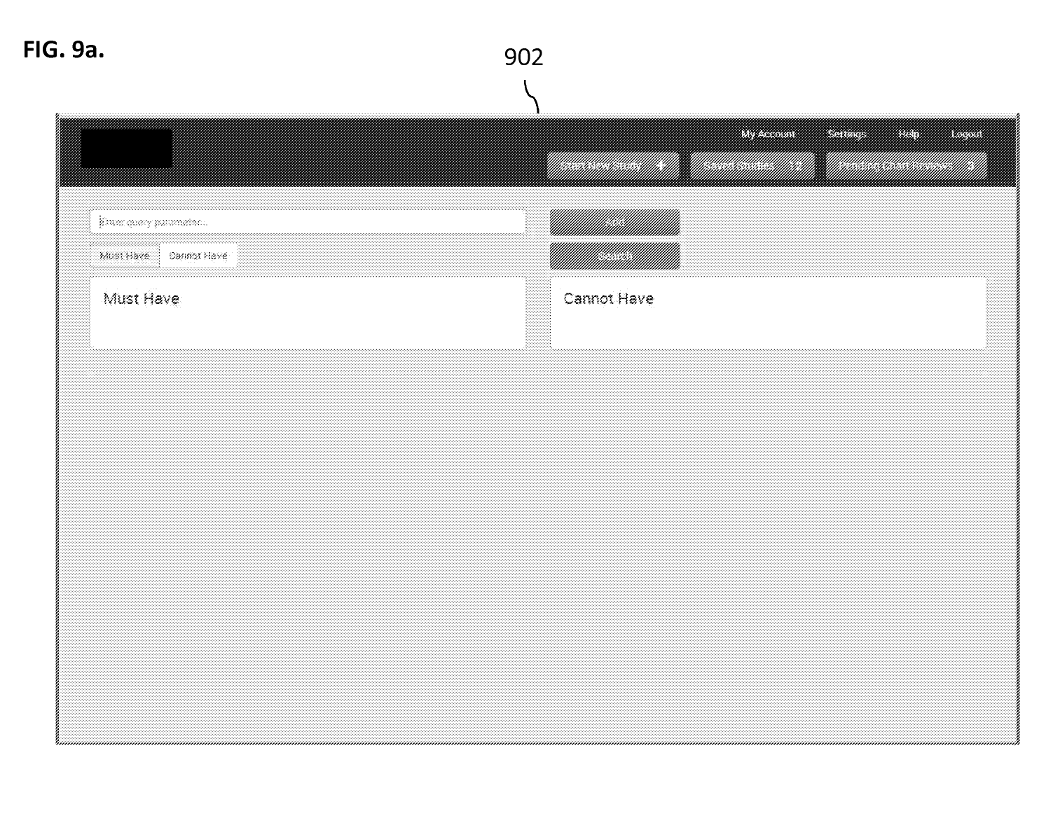

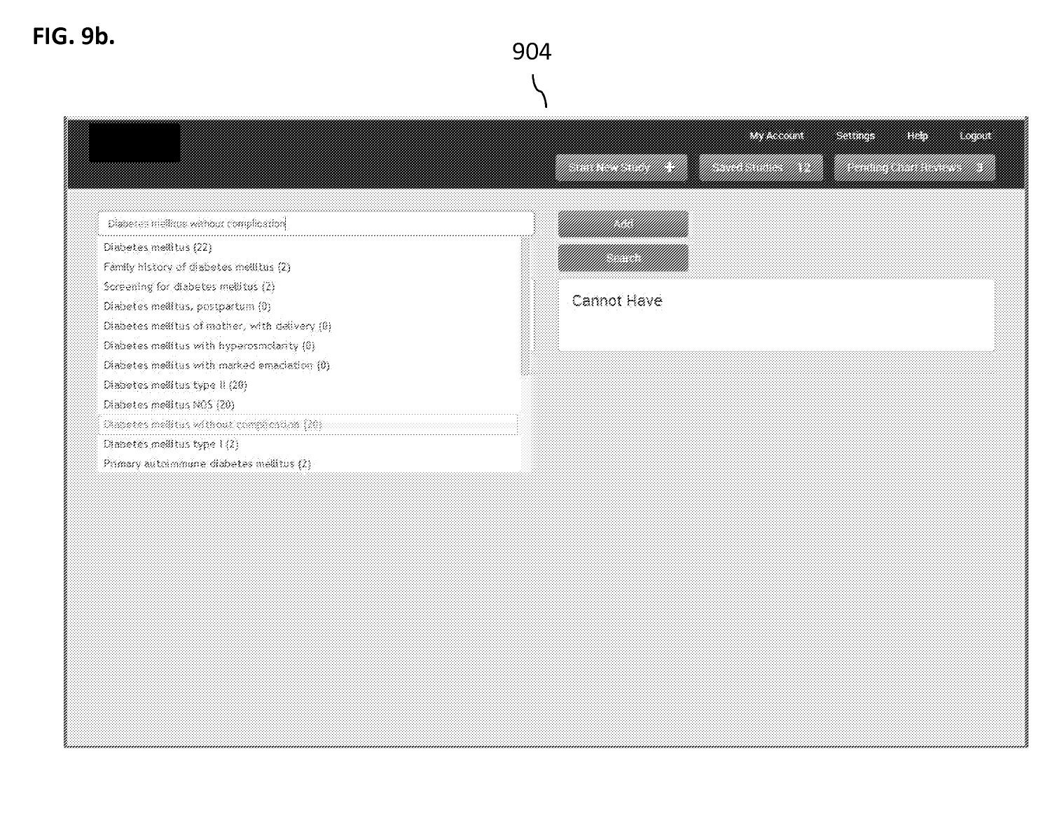

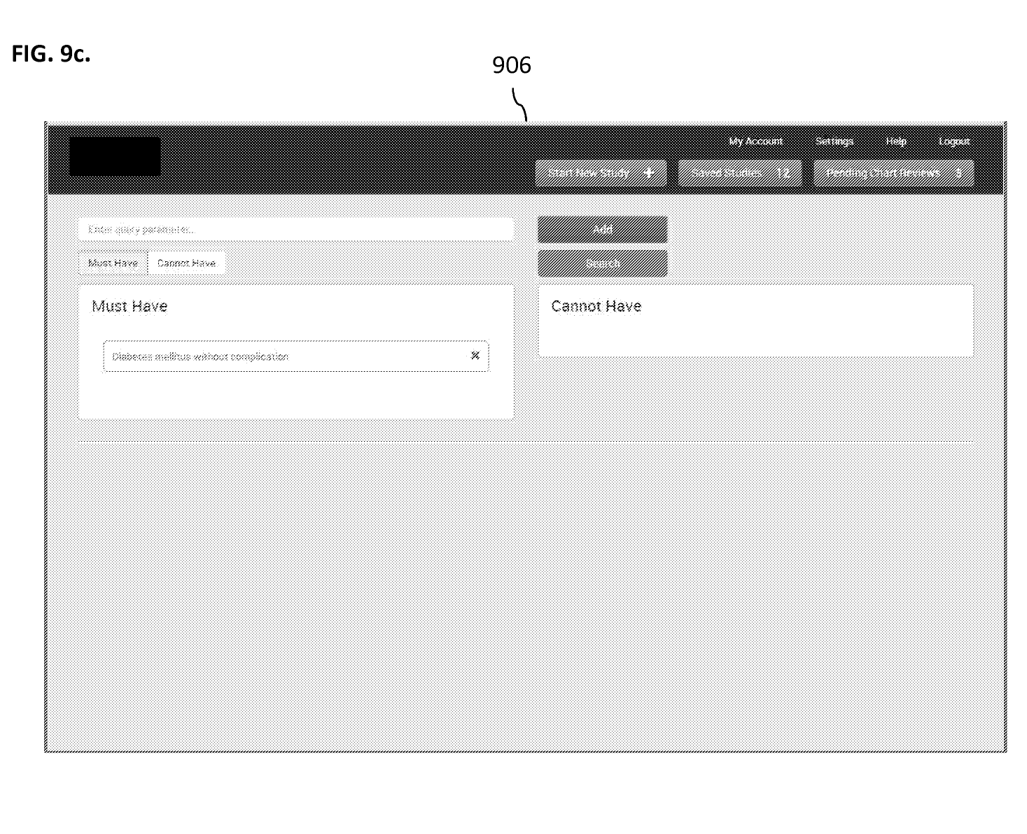

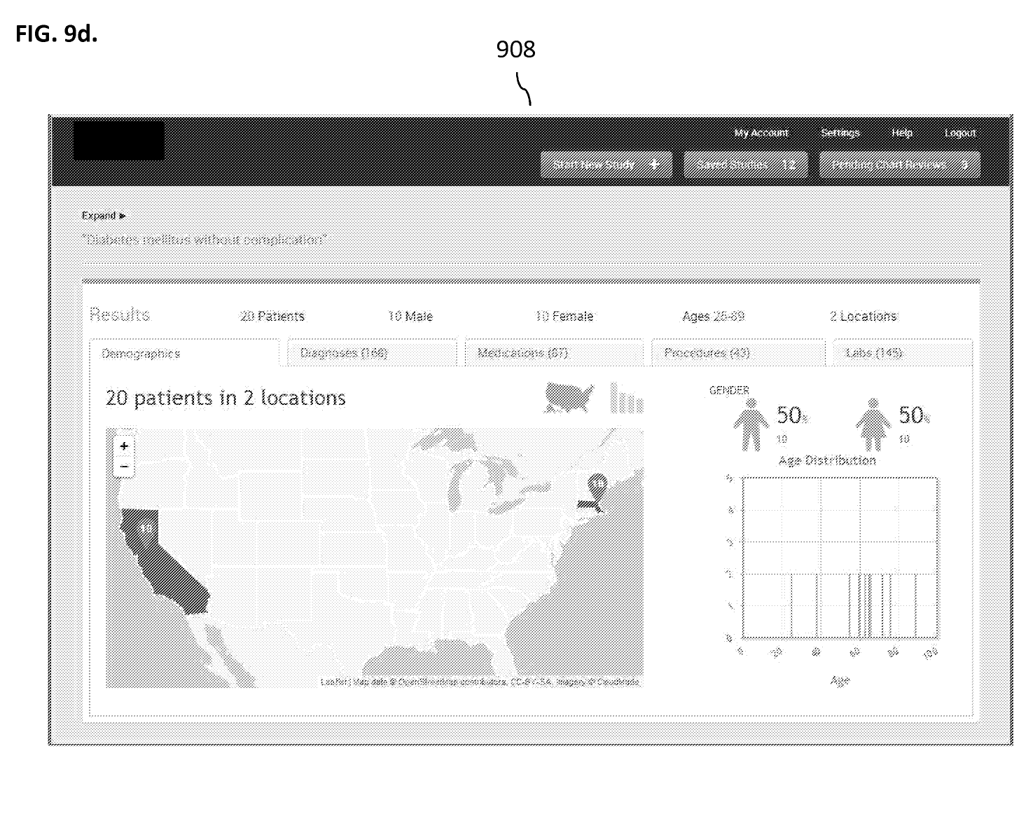

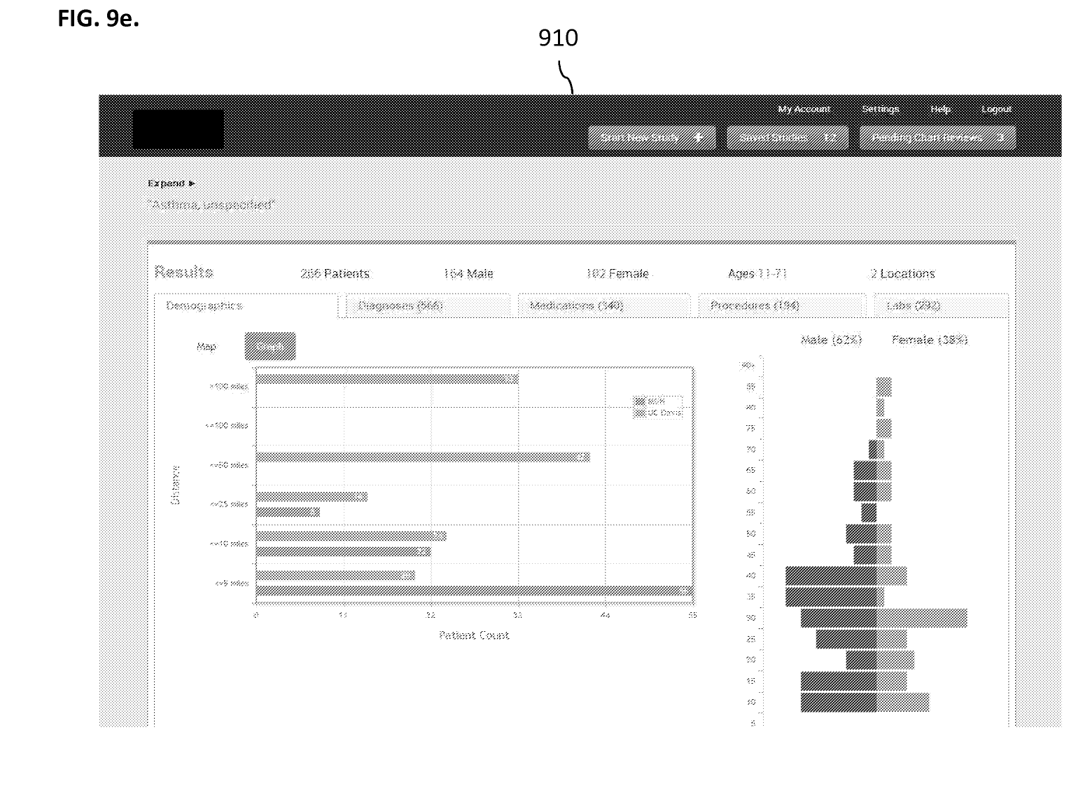

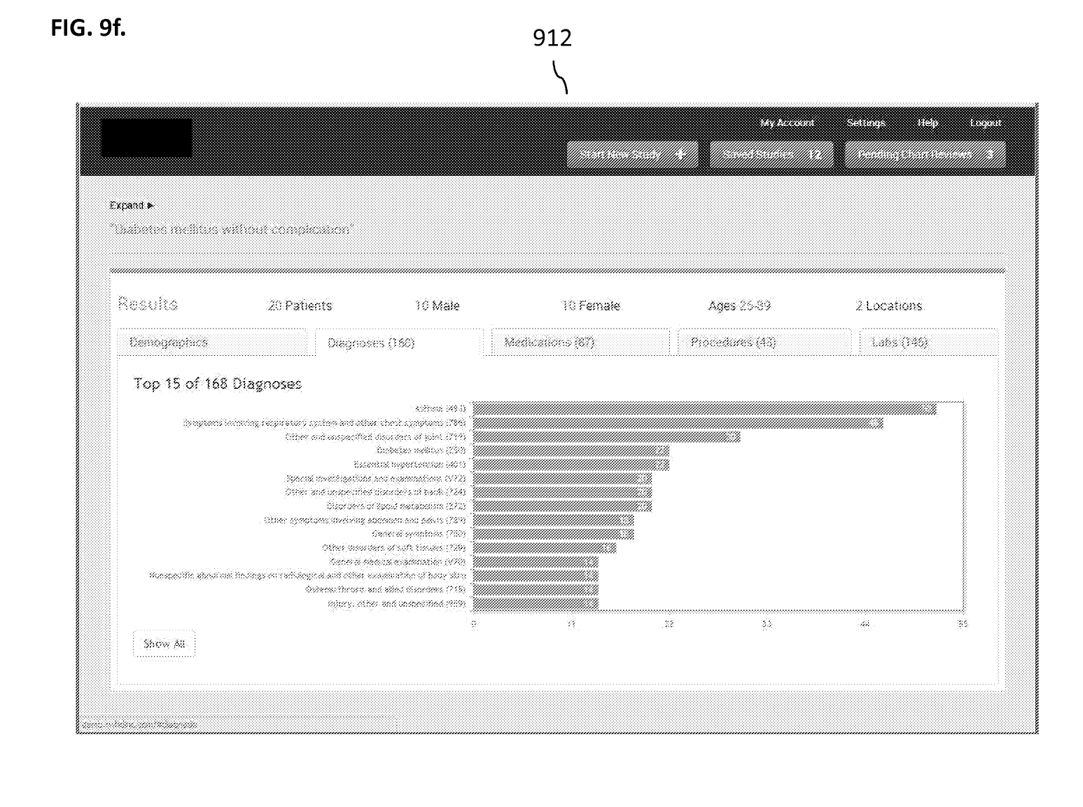

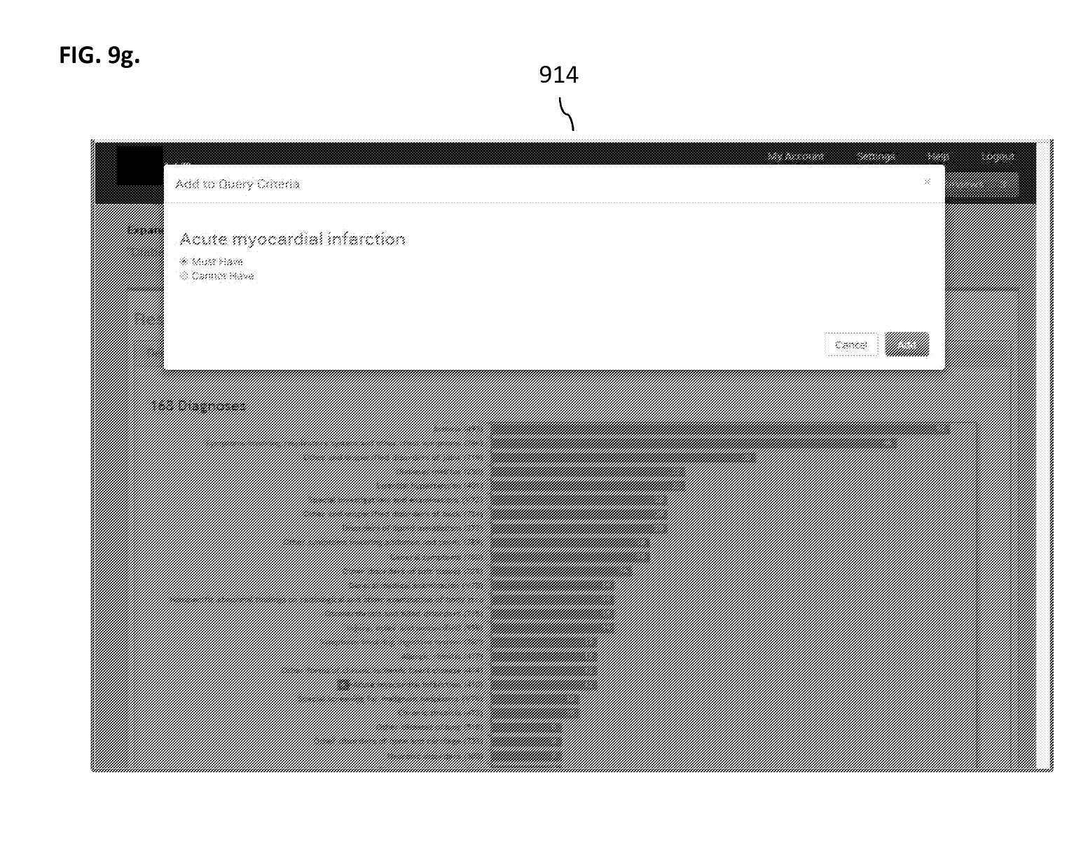

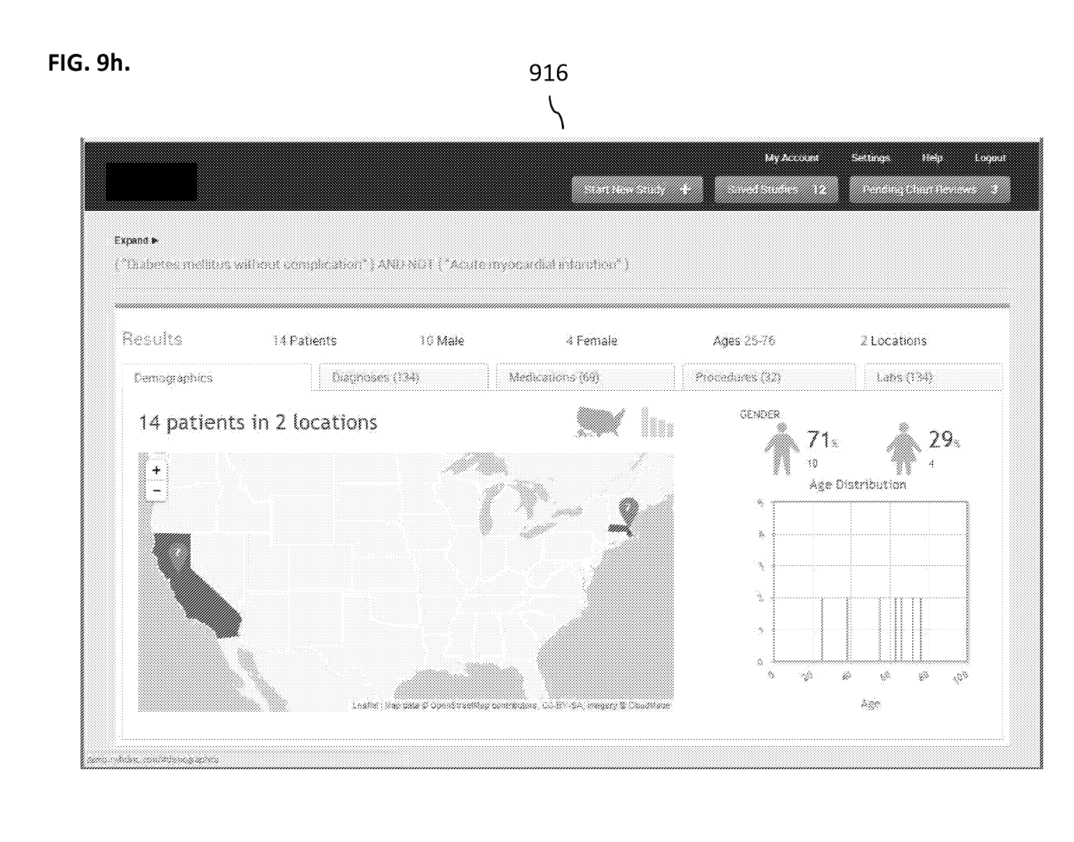

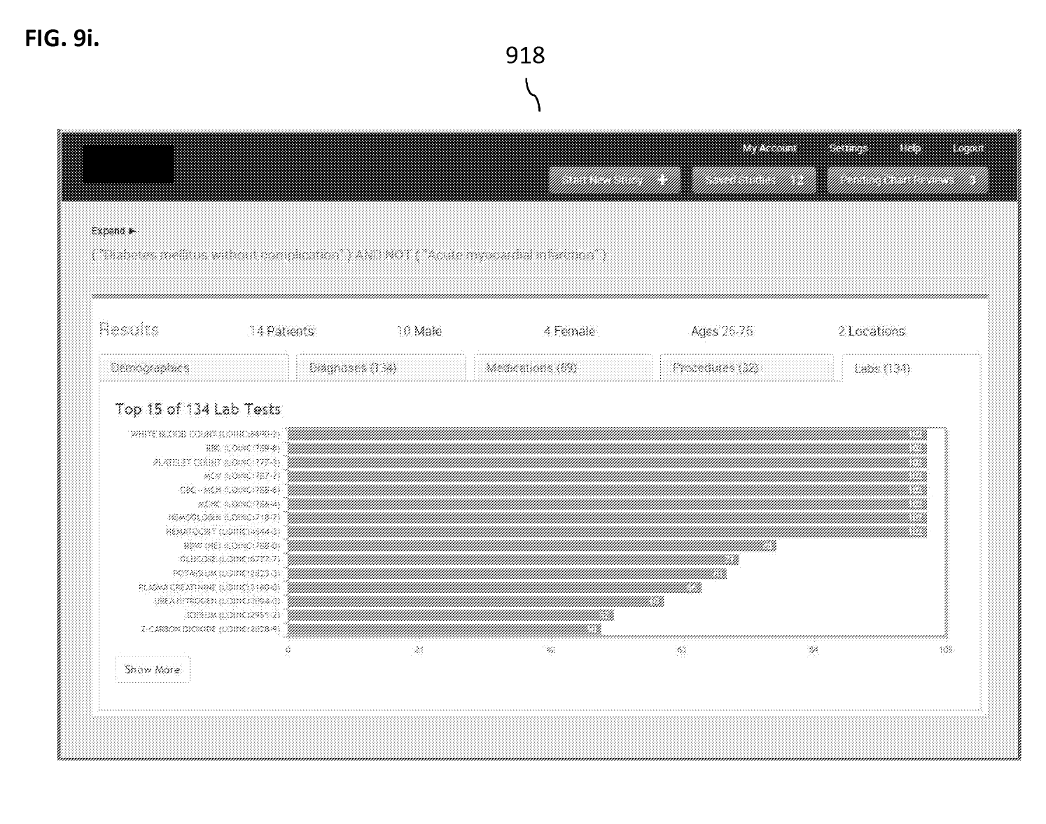

FIGS. 9a-9i illustrate various exemplary user interfaces that can be used to assist the user during any of the processes discussed above in connection with FIG. 5. The user interfaces can be generated using the platform 704 and can be displayed using user browser 702, as shown in FIG. 7.

Exemplary user interface 902 shown in FIG. 9a can be an initial user interface that can be used to begin exploratory research process 502 and initiate a query for patients, sites, etc. The user can enter any query criteria (e.g., “must have”, “cannot have” parameters, etc.) that the user feels would assist the user in generating results.

Exemplary user interface 904 shown in FIG. 9b can assist the user with entering information about a particular disease that the user wishes to study. The potential results can be displayed in a drop down menu and can be coded using various adopted standards. Additionally, each potential result can also display a potential number of patient candidates that can be available for a study associated with a particular medical condition.

FIG. 9c illustrates an exemplary user interface 906 that includes a particular user-selected medical condition (“Diabetes mellitus without complication”), as a must-have condition.

FIG. 9d illustrates an exemplary user interface 908 that illustrate a geographical map and a number of patient candidates at each geographical location that can have a particular medical condition that has been selected by the user. The map can display ages of patients as well as any other information. FIG. 9e illustrates an exemplary user interface 910 that can show a distribution of potential patient candidates based on a distance from a particular location (e.g., the user, a potential site, etc.). The users can be broken down by various criteria (e.g., age, gender, medical condition, diagnosis, etc.). FIG. 9f illustrates an exemplary user interface 912 containing a histogram of diagnoses associated with potential patient candidates (including a number of patients having a particular diagnosis). FIG. 9g illustrates an exemplary user interface 914 that can allow the user to narrow the searching criteria by entering various parameters (e.g., “potential patient candidates must have acute myocardial infraction”). A result of such narrowing is shown in the map of potential patient candidates in an exemplary user interface 916 shown in FIG. 9h. FIG. 9i illustrates an exemplary user interface 918 that contains information about laboratory results of potential patient candidates. Other user interfaces that contain information about “demographics”, “diagnoses”, “medications”, “procedures”, etc. can also be generated for the user to view. The user can also narrow down and/or expand search results by entering “must have” and/or “cannot have” criteria. The current subject matter can also provide various optional criteria to assist the user in searching for the potential patient candidates.

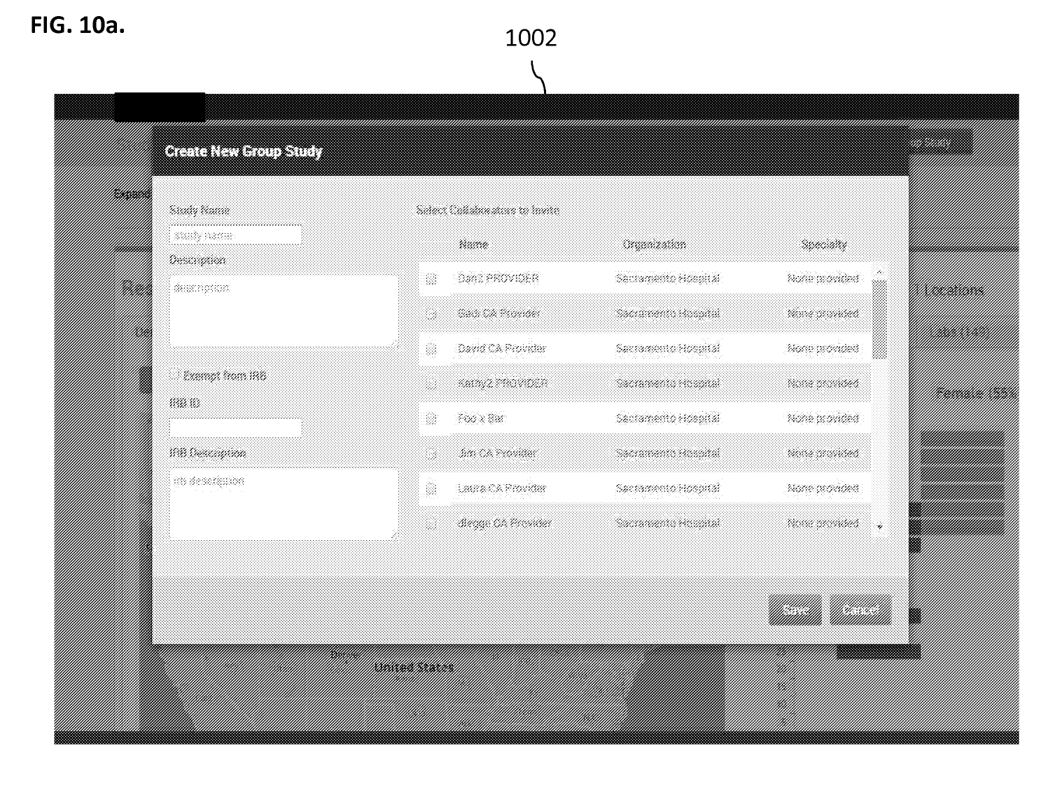

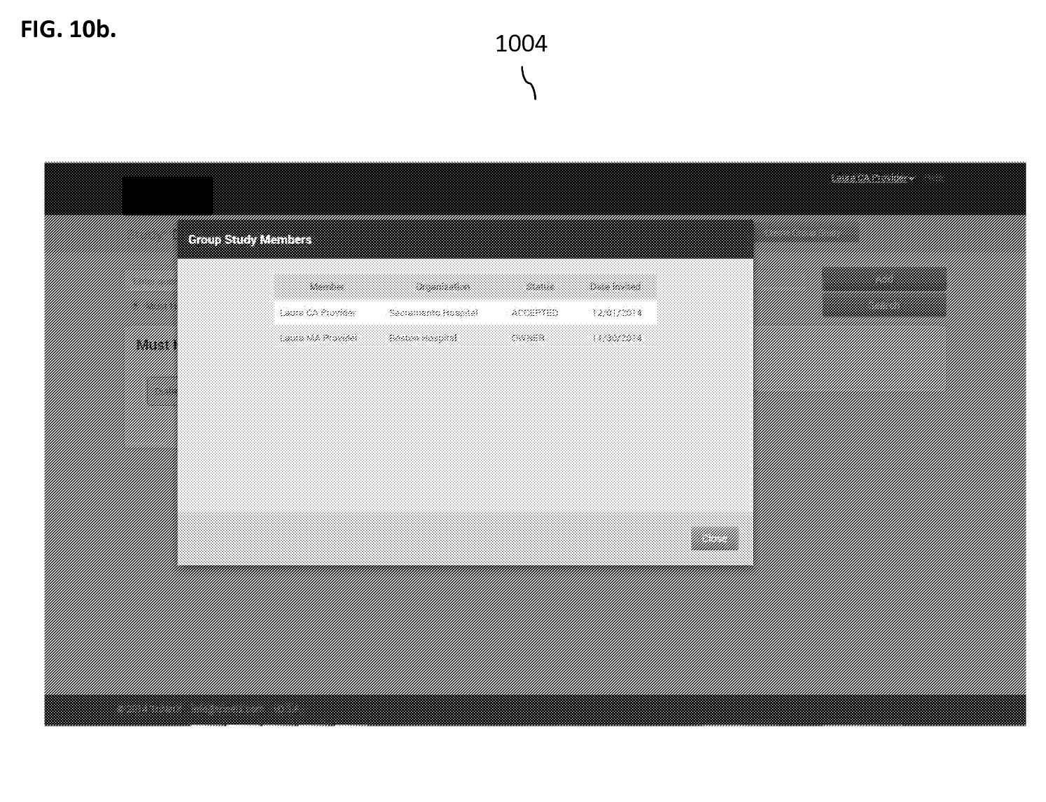

FIGS. 10a-10b illustrate exemplary user interfaces that can assist the user in creating a peer network (such as the network 802 shown in FIG. 8). Using user interface 1002 shown in FIG. 10a, the user can identify specific collaborators (e.g., “Dan2 PROVIDER”) from various providers (e.g., “Sacramento Hospital”). The user can also provide a name, description, identification information, etc. for the collaboration study. Additionally, the user can specify IRB information and any associated description. The user can then select specific collaborators for the collaboration study. An exemplary result of the user's selections is illustrated in the user interface 1004 shown in FIG. 10b.

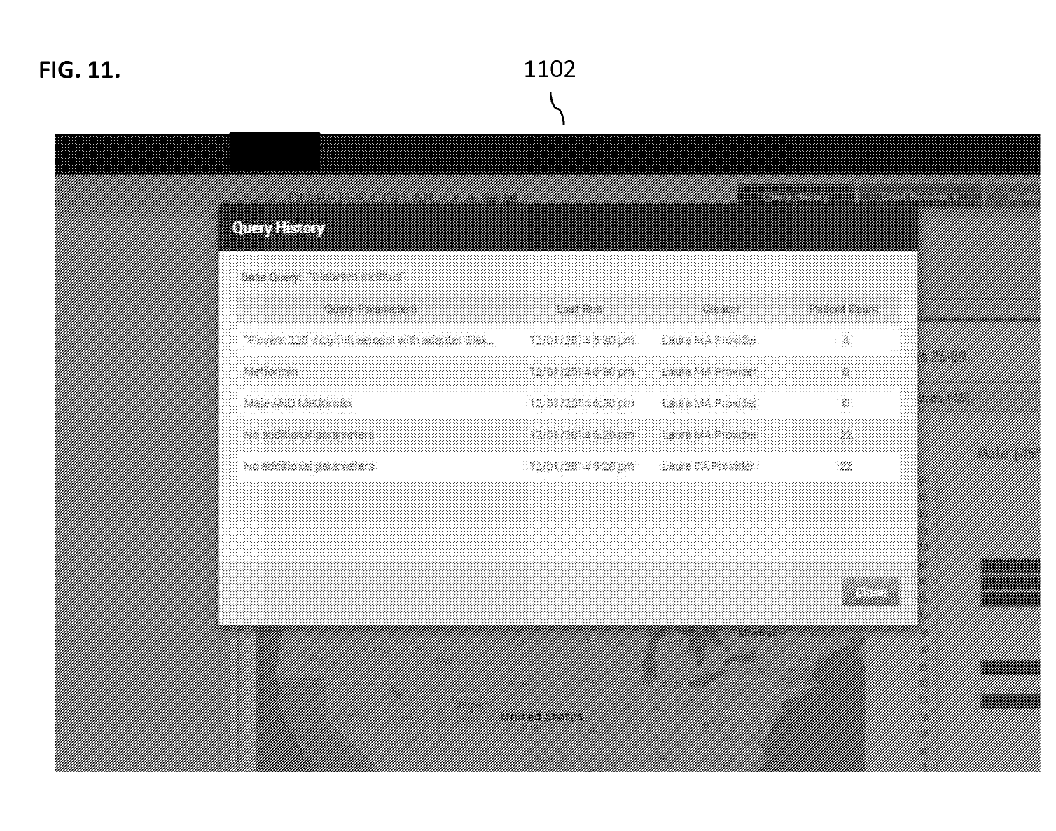

FIG. 11 illustrates an exemplary user interface 1102 that can allow the user to track queries that are being performed (by the user and/or by a collaborator in the network shown in FIG. 8), including query parameters, dates of queries, identity of the creator of the query, and results generated by the query.

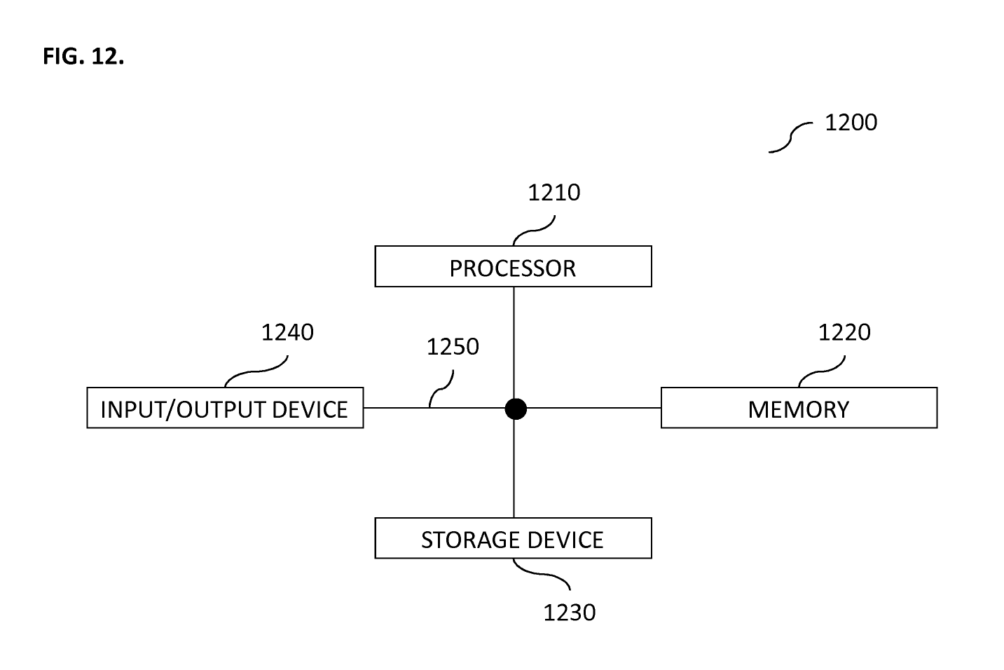

In some implementations, the current subject matter can be configured to be implemented in a system 1200, as shown in FIG. 12. The system 1200 can include a processor 1210, a memory 1220, a storage device 1230, and an input/output device 1240. Each of the components 1210, 1220, 1230 and 1240 can be interconnected using a system bus 1250. The processor 1210 can be configured to process instructions for execution within the system 1200. In some implementations, the processor 1210 can be a single-threaded processor. In alternate implementations, the processor 1210 can be a multi-threaded processor. The processor 1210 can be further configured to process instructions stored in the memory 1220 or on the storage device 1230, including receiving or sending information through the input/output device 1240. The memory 1220 can store information within the system 1200. In some implementations, the memory 1220 can be a computer-readable medium. In alternate implementations, the memory 1220 can be a volatile memory unit. In yet some implementations, the memory 1220 can be a non-volatile memory unit. The storage device 1230 can be capable of providing mass storage for the system 1200. In some implementations, the storage device 1230 can be a computer-readable medium. In alternate implementations, the storage device 1230 can be a floppy disk device, a hard disk device, an optical disk device, a tape device, non-volatile solid state memory, or any other type of storage device. The input/output device 1240 can be configured to provide input/output operations for the system 1200. In some implementations, the input/output device 1240 can include a keyboard and/or pointing device. In alternate implementations, the input/output device 1240 can include a display unit for displaying graphical user interfaces.

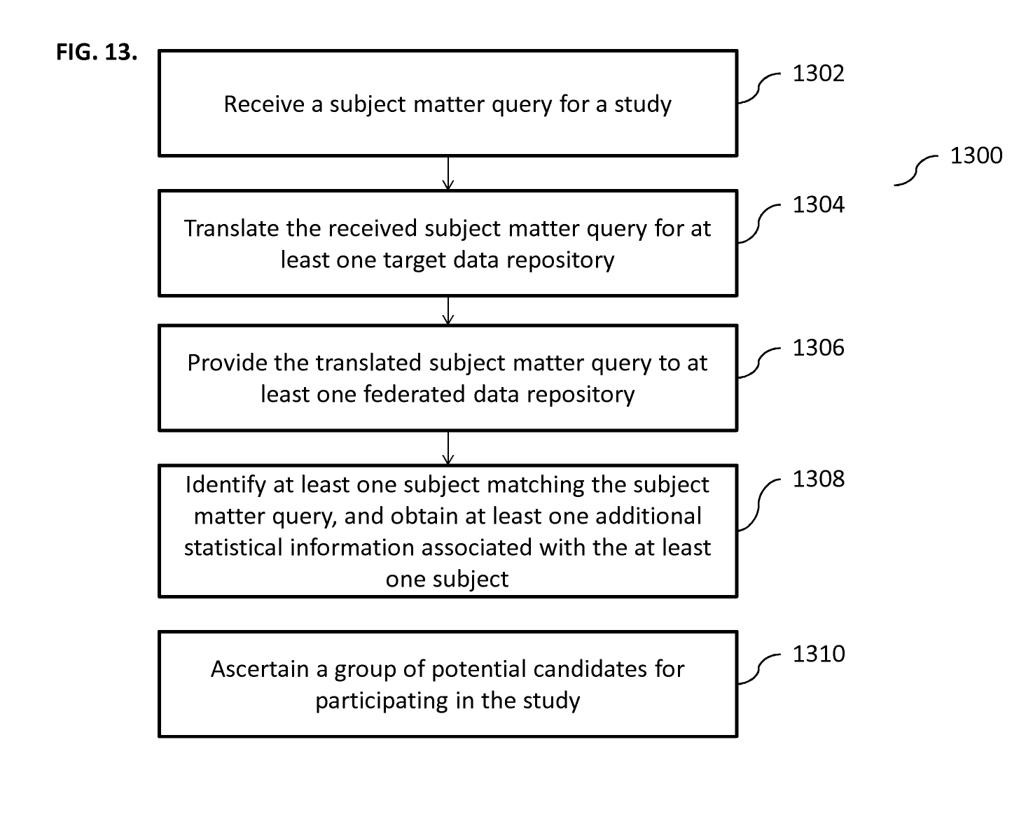

FIG. 13 illustrates an exemplary method 1300 for identifying candidates for a clinical study (and/or any other purpose, e.g., a joint venture, a research project, etc.), according to some implementations of the current subject matter. At 1302, a subject matter query for a study can be received (the query can be issued by the user of the system 100 shown in FIG. 1). At 1304, the received subject matter query can be translated for at least one target data repository (e.g., provider data repository and/or any other storage location). At 1306, the translated subject matter query can be provided to at least one federated data repository (e.g., the repository, database, and/or other storage location of the system 100 shown in FIG. 1). At 1308, at least one subject matching the subject matter query can be identified using the federated data repository. At least one additional statistical information (e.g., patient statistics, site statistics, medical condition statistics, etc.) associated with the at least one subject can be also obtained from the federated data repository. The obtained additional statistical information can be translated to common terminology (e.g., terminology that may be known to those in the field of the study and/or medical field in general and/or any other field). At 1310, a group of potential candidates for participating in the study can be ascertained based on the identified subject.

In some implementations, the current subject matter can include one or more of the following optional features. At least one location and at least one principal investigator associated with the at least one location for conducting the study can be identified based on a protocol (e.g., a clinical protocol). The location can be a hospital, a clinic, a medical facility, a laboratory, and/or any other facility. The location can be a site that a patient candidate visits and/or visited in the past and/or plans to visit in the future for the purposes of receiving medical services and/or treatment. The principal investigator can be an individual that can be associated with the site and/or can be an independent investigator. The principal investigator can conduct and oversee the study in accordance with the protocol. The protocol can contain subject matter for generating the subject matter query.

In some implementations, a first group of candidates to participate in the study can be selected based on the identified location and the principal investigator. The candidates in the group can be contacted to determine whether they are willing to participate in the study. The participants can be offered compensation and/or other benefits. Once a candidate agrees to participate, the candidate can be required to visit the location where the study will be conducted and execute various consent forms and/or any other agreements. The first group of candidates can be selected from the above group of potential candidates.

In some implementations, the current subject matter can include one or more of the following optional features. The study can be a clinical study and the protocol can be a clinical protocol for the clinical study.

In some implementations, a second group of candidates can be identified in response to receiving a first query. The first query can include at least one parameter that can characterize the clinical study. The user 106 (shown in FIG. 1) can issue the query to the provider network 102 for the purposes of selecting potential patient candidates that can be recruited for the study. The selected candidates can be selected from the second group of candidates.

In some implementations, the clinical protocol for conducting the clinical study can be generated and/or created based on at least one of the following: the identified second group of candidates and an existing clinical protocol. The protocol can be designed by the user 102 (e.g., a physician) and can involve review of information associated with identified candidates, their medical histories, medical conditions, when they accessed a provider (e.g., provider 104 shown in FIG. 1) for treatment, etc. The data that can be accessible to the provider can be anonymized or de-identified so that the provider does not know specific personal information about each patient candidate. The protocol can be reviewed by user's peers and the user can consult with experts in the field of the clinical study.

In some implementations, at least one parameter can include data describing at least one of the following: a medical condition, a pharmaceutical compound, a medical device, a patient population, and any combination thereof. Further, at least one parameter can include at least one of the following: demographic data, medical diagnosis, medical procedure, medications, laboratory test results, genomic sequence data, mutation data, variant data, biomarker data, and/or any combination there.

In some implementations, the method 1300 can include identifying at least one expert to assist the at least one clinical investigator in conducting the clinical study.

In some implementations, the identification of the second group of candidates can include retrieving of at least one medical record associated with each candidate in the second group of candidates. The candidates in the second group of candidates can be selected based on the retrieved medical records. The medical record can include at least one of the following: anonymized data associated with at least one candidate in the second candidate group and data identifying at least one candidate in the second candidate group.

In some implementations, the site can include at least one of the following: a hospital, a clinic, a medical facility, a pharmaceutical company, a laboratory, and a medical office. The site can be identified based on at least one of the following: a distance between locations of candidates in the second candidate group and a location of the site, a time when at least one candidate in the second candidate group has requested and/or received medical services from the site, a type of medical condition being involved in the clinical study, age of at least one candidate in the second candidate group, gender of at least one candidate in the second candidate group, race of at least one candidate in the second candidate group, and/or any other characteristics of at least one candidate in the second candidate group, expertise of the site in a medical field, experience of the site in treating at least one medical condition, availability of particular medical equipment at the site, at least one treatment protocols implemented by the site, and any combination thereof.

In some implementations, the method 1300 can further include communicating with a plurality of sites to establish a peer-to-peer network for jointly conducting the clinical study, and establishing the peer-to-peer network of sites for conducting the clinical study. The method can also include creating at least one filter for filtering access to data of at least one site in the peer-to-peer network, and preventing at least one site in the peer-to-peer network from accessing data of at least another site in the peer-to-peer network based on the created filter. The method can further include identifying, for each site in the peer-to-peer network, at least one principal investigator associated with the site. The plurality of identified principal investigators can jointly conduct the clinical study.

In some implementations, the method 1300 can include executing at least one additional query to reduce a number of candidates in the second group of candidates.

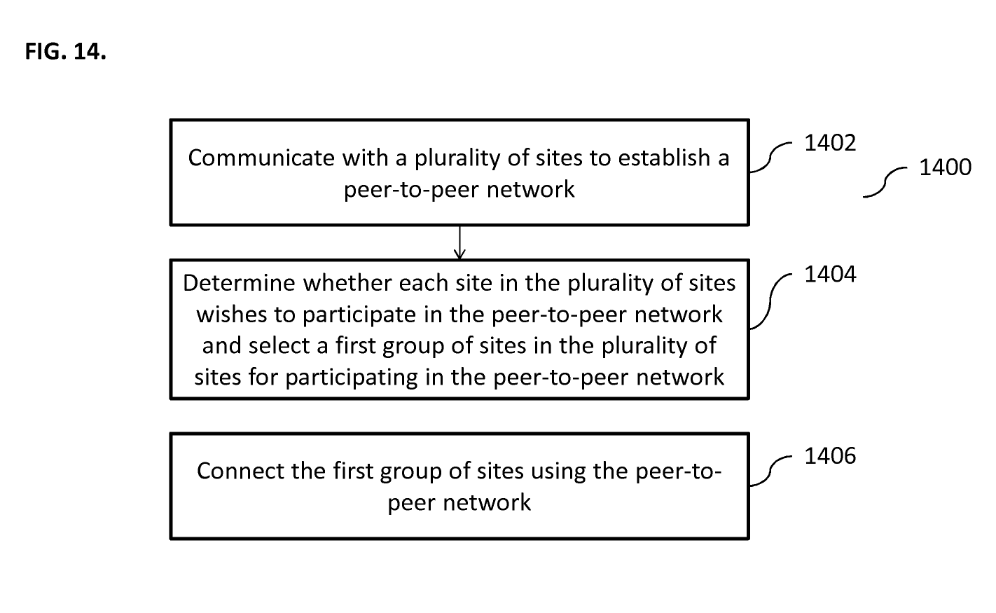

In some implementations, the current subject matter relates to a computer-implemented method 1400 for establishing a peer-to-peer network, as shown in FIG. 14. The network can be established for various reasons, including but not limited, to at least one of the following: a clinical study, a research project, a collaborative project, a joint venture, and/or any other purposes, and/or any combination thereof. The network can be used to, for example, to identify candidates for participating in a clinical study and collaboratively conducting the clinical study. The method can include communicating with a plurality of sites to establish a peer-to-peer network (at 1402), determining whether each site in the plurality of sites wishes to participate in the peer-to-peer network and selecting a first group of sites in the plurality of sites for participating in the peer-to-peer network (at 1404), and connecting the first group of sites using the peer-to-peer network (at 1406).

In some implementations, the current subject matter can include one or more of the following optional features. At least one filter for filtering access to data of at least one site in the peer-to-peer network can be created. Based on the created at least one filter, at least one site in the first group of sites can be prevented from accessing data of at least another site in the first group of sites. The method 1400 can also include identifying, for each site in the first group of sites, at least one principal investigator associated with the site. The plurality of identified principal investigators can jointly conduct at least one of the following: a clinical study, a research project, a collaborative project, a joint venture, and/or any combination thereof.

While the invention has been described with respect to the above illustrated embodiments, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the current subject matter.

Therefore, the foregoing is considered as illustrative only of the principles of the invention. Further, since numerous modifications and changes will readily occur to those skilled in the art, it is not described to limit the invention to the exact construction and operation shown and described and accordingly, all suitable modifications and equivalents may be resorted to, falling within the scope of the invention.

Having described illustrative embodiments of the current subject matter with reference to the accompanying drawings, it will be appreciated that the current subject matter is not limited to the illustrated embodiments and that various changes and modifications can be effected therein by one of ordinary skill in the art without departing from the scope or spirit of the current subject matter as defined by the appended claims. Further modifications of the current subject matter can also occur to persons skilled in the art and all such are deemed to fall within the spirit and scope of the invention as defined by the appended claims.

Although particular embodiments have been disclosed herein in detail, this has been done by way of example and for purposes of illustration only, and is not intended to be limiting. In particular, it is contemplated by the inventors that various substitutions, alterations, and modifications may be made without departing from the spirit and scope of the disclosed embodiments. Other aspects, advantages, and modifications are considered to be within the scope of the disclosed and claimed embodiments, as well as other inventions disclosed herein. The claims presented hereafter are merely representative of some of the embodiments of the inventions disclosed herein. Other, presently unclaimed embodiments and inventions are also contemplated. The inventors reserve the right to pursue such embodiments and inventions in later claims and/or later applications claiming common priority.

As used herein, the term “user” can refer to any entity including a person or a computer or any other device.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

1. A computer implemented method comprising:
receiving a subject matter query for a study;
translating the received subject matter query for at least one target data repository;
providing the translated subject matter query to at least one federated data repository;
identifying, using the at least one federated data repository, at least one subject matching the subject matter query, and obtaining at least one additional statistical information associated with the at least one subject, wherein the obtained at least one additional statistical information is translated to common terminology; and
ascertaining, based on the identified at least one subject, a group of potential candidates for participating in the study;
wherein at least one of the receiving, the translating, the providing, the identifying, and the ascertaining is performed by at least one processor of at least one computing system.

2. The method according to claim 1, further comprising
identifying, based on a protocol, at least one location and at least one principal investigator associated with the at least one location for conducting a study, the protocol containing subject matter for generating the subject matter query; and
selecting, based on the identified at least one location and the at least one principal investigator, a first group of candidates to participate in the study, the at least one principal investigator conducts the study, the first group of candidates is selected from the group of potential candidates.

3. The method according to claim 2, wherein the study is a clinical study and a protocol is a clinical protocol for the clinical study.

4. The method according to claim 3, wherein the identifying further comprises
identifying a second group of candidates in response to receiving a first query, the first query including at least one parameter characterizing the clinical study;
wherein the clinical protocol is generated based on at least one of the following: the second group of candidates and an existing clinical protocol.

5. The method according to claim 4, wherein the selected group of candidates is selected from the second group of candidates.

6. The method according to claim 4, wherein the at least one parameter includes data describing at least one of the following: a medical condition, a pharmaceutical compound, a medical device, a patient population, and any combination thereof.

7. The method according to claim 4, wherein the at least one parameter includes at least one of the following: demographic data, medical diagnosis, medical procedure, medications, laboratory test results, genomic sequence data, mutation data, variant data, biomarker data, and/or any combination there.

8. The method according to claim 2, further comprising identifying at least one expert to assist the at least one principal investigator in conducting the study.

9. The method according to claim 4, wherein the identifying the second group of candidates includes retrieving at least one medical record associated with each candidate in the second group of candidates;
wherein the candidates in the selected group of candidates are selected based on the retrieved at least one medical record.

10. The method according to claim 9, wherein the at least one medical record includes at least one of the following: anonymized data associated with at least one candidate in the second group of candidates and data identifying at least one candidate in the second group of candidates.

11. The method according to claim 2, wherein the site includes at least one of the following: a hospital, a clinic, a medical facility, a pharmaceutical company, a laboratory, and a medical office.

12. The method according to claim 11, wherein the site is identified based on at least one of the following: a distance between locations of candidates in the second group of candidates and a location of the site, a time when at least one candidate in the second group of candidates has requested and/or received medical services from the site, a type of medical condition being involved in the clinical study, age of at least one candidate in the second group of candidates, gender of at least one candidate in the second group of candidates, race of at least one candidate in the second group of candidates, and/or any other characteristics of at least one candidate in the second group of candidates, expertise of the site in a medical field, experience of the site in treating at least one medical condition, availability of particular medical equipment at the site, at least one treatment protocols implemented by the site, and any combination thereof.

13. The method according to claim 1, further comprising
communicating with a plurality of sites to establish a peer-to-peer network for jointly conducting the study; and
establishing the peer-to-peer network of sites for conducting the study.

14. The method according to claim 13, further comprising
creating at least one filter for filtering access to data of at least one site in the peer-to-peer network; and
preventing, based on the created at least one filter, at least one site in the peer-to-peer network from accessing data of at least another site in the peer-to-peer network.

15. The method according to claim 13, further comprising
identifying, for each site in the peer-to-peer network, at least one principal investigator associated with the site;
wherein the plurality of identified principal investigators jointly conduct the study.

16. The method according to claim 4, further comprising
executing at least one additional query to reduce a number of candidates in the second group of candidates.

17. A computer program product comprising a machine-readable medium storing instructions that, when executed by at least one programmable processor, cause the at least one programmable processor to perform operations comprising:
receiving a subject matter query for a study;
translating the received subject matter query for at least one target data repository;
providing the translated subject matter query to at least one federated data repository;
identifying, using the at least one federated data repository, at least one subject matching the subject matter query, and obtaining at least one additional statistical information associated with the at least one subject, wherein the obtained at least one additional statistical information is translated to common terminology; and
ascertaining, based on the identified at least one subject, a group of potential candidates for participating in the study.

18. The computer program product according to claim 17, wherein the operations further comprise
identifying, based on a protocol, at least one location and at least one principal investigator associated with the at least one location for conducting a study, the protocol containing subject matter for generating the subject matter query; and
selecting, based on the identified at least one location and the at least one principal investigator, a first group of candidates to participate in the study, the at least one principal investigator conducts the study, the first group of candidates is selected from the group of potential candidates.

19. The computer program product according to claim 18, wherein the study is a clinical study and a protocol is a clinical protocol for the clinical study.

20. The computer program product according to claim 19, wherein the identifying further comprises
identifying a second group of candidates in response to receiving a first query, the first query including at least one parameter characterizing the clinical study;
wherein the clinical protocol is generated based on at least one of the following: the second group of candidates and an existing clinical protocol.

21. The computer program product according to claim 20, wherein the selected group of candidates is selected from the second group of candidates.

22. The computer program product according to claim 20, wherein the at least one parameter includes data describing at least one of the following: a medical condition, a pharmaceutical compound, a medical device, a patient population, and any combination thereof.

23. The computer program product according to claim 20, wherein the at least one parameter includes at least one of the following: demographic data, medical diagnosis, medical procedure, medications, laboratory test results, genomic sequence data, mutation data, variant data, biomarker data, and/or any combination there.

24. The computer program product according to claim 18, wherein the operations further comprise identifying at least one expert to assist the at least one principal investigator in conducting the study.

25. The computer program product according to claim 20, wherein the identifying the second group of candidates includes retrieving at least one medical record associated with each candidate in the second group of candidates;
wherein the candidates in the selected group of candidates are selected based on the retrieved at least one medical record.

26. The computer program product according to claim 25, wherein the at least one medical record includes at least one of the following: anonymized data associated with at least one candidate in the second group of candidates and data identifying at least one candidate in the second group of candidates.

27. The computer program product according to claim 18, wherein the site includes at least one of the following: a hospital, a clinic, a medical facility, a pharmaceutical company, a laboratory, and a medical office.

28. The computer program product according to claim 27, wherein the site is identified based on at least one of the following: a distance between locations of candidates in the second group of candidates and a location of the site, a time when at least one candidate in the second group of candidates has requested and/or received medical services from the site, a type of medical condition being involved in the clinical study, age of at least one candidate in the second group of candidates, gender of at least one candidate in the second group of candidates, race of at least one candidate in the second group of candidates, and/or any other characteristics of at least one candidate in the second group of candidates, expertise of the site in a medical field, experience of the site in treating at least one medical condition, availability of particular medical equipment at the site, at least one treatment protocols implemented by the site, and any combination thereof.

29. The computer program product according to claim 17, wherein the operations further comprise
communicating with a plurality of sites to establish a peer-to-peer network for jointly conducting the study; and
establishing the peer-to-peer network of sites for conducting the study.

30. The computer program product according to claim 29, wherein the operations further comprise
creating at least one filter for filtering access to data of at least one site in the peer-to-peer network; and
preventing, based on the created at least one filter, at least one site in the peer-to-peer network from accessing data of at least another site in the peer-to-peer network.

31. The computer program product according to claim 29, wherein the operations further comprise
identifying, for each site in the peer-to-peer network, at least one principal investigator associated with the site;
wherein the plurality of identified principal investigators jointly conduct the study.

32. The computer program product according to claim 20, wherein the operations further comprise
executing at least one additional query to reduce a number of candidates in the second group of candidates.

33. A system comprising:
at least one programmable processor; and
a machine-readable medium storing instructions that, when executed by the at least one programmable processor, cause the at least one programmable processor to perform operations comprising:
receiving a subject matter query for a study;
translating the received subject matter query for at least one target data repository;
providing the translated subject matter query to at least one federated data repository;
identifying, using the at least one federated data repository, at least one subject matching the subject matter query, and obtaining at least one additional statistical information associated with the at least one subject, wherein the obtained at least one additional statistical information is translated to common terminology; and
ascertaining, based on the identified at least one subject, a group of potential candidates for participating in the study.

34. The system according to claim 33, wherein the operations further comprise
identifying, based on a protocol, at least one location and at least one principal investigator associated with the at least one location for conducting a study, the protocol containing subject matter for generating the subject matter query; and
selecting, based on the identified at least one location and the at least one principal investigator, a first group of candidates to participate in the study, the at least one principal investigator conducts the study, the first group of candidates is selected from the group of potential candidates.

35. The system according to claim 34, wherein the study is a clinical study and a protocol is a clinical protocol for the clinical study.

36. The system according to claim 35, wherein the identifying further comprises
identifying a second group of candidates in response to receiving a first query, the first query including at least one parameter characterizing the clinical study;
wherein the clinical protocol is generated based on at least one of the following: the second group of candidates and an existing clinical protocol.

37. The system according to claim 36, wherein the selected group of candidates is selected from the second group of candidates.

38. The system according to claim 36, wherein the at least one parameter includes data describing at least one of the following: a medical condition, a pharmaceutical compound, a medical device, a patient population, and any combination thereof.

39. The system according to claim 36, wherein the at least one parameter includes at least one of the following: demographic data, medical diagnosis, medical procedure, medications, laboratory test results, genomic sequence data, mutation data, variant data, biomarker data, and/or any combination there.

40. The system according to claim 34, wherein the operations further comprise identifying at least one expert to assist the at least one principal investigator in conducting the study.

41. The system according to claim 36, wherein the identifying the second group of candidates includes retrieving at least one medical record associated with each candidate in the second group of candidates;
wherein the candidates in the selected group of candidates are selected based on the retrieved at least one medical record.

42. The system according to claim 41, wherein the at least one medical record includes at least one of the following: anonymized data associated with at least one candidate in the second group of candidates and data identifying at least one candidate in the second group of candidates.

43. The system according to claim 34, wherein the site includes at least one of the following: a hospital, a clinic, a medical facility, a pharmaceutical company, a laboratory, and a medical office.

44. The system according to claim 43, wherein the site is identified based on at least one of the following: a distance between locations of candidates in the second group of candidates and a location of the site, a time when at least one candidate in the second group of candidates has requested and/or received medical services from the site, a type of medical condition being involved in the clinical study, age of at least one candidate in the second group of candidates, gender of at least one candidate in the second group of candidates, race of at least one candidate in the second group of candidates, and/or any other characteristics of at least one candidate in the second group of candidates, expertise of the site in a medical field, experience of the site in treating at least one medical condition, availability of particular medical equipment at the site, at least one treatment protocols implemented by the site, and any combination thereof.

45. The system according to claim 33, wherein the operations further comprise
communicating with a plurality of sites to establish a peer-to-peer network for jointly conducting the study; and
establishing the peer-to-peer network of sites for conducting the study.

46. The system according to claim 45, wherein the operations further comprise
creating at least one filter for filtering access to data of at least one site in the peer-to-peer network; and
preventing, based on the created at least one filter, at least one site in the peer-to-peer network from accessing data of at least another site in the peer-to-peer network.

47. The system according to claim 45, wherein the operations further comprise
identifying, for each site in the peer-to-peer network, at least one principal investigator associated with the site;
wherein the plurality of identified principal investigators jointly conduct the study.

48. The system according to claim 36, wherein the operations further comprise
executing at least one additional query to reduce a number of candidates in the second group of candidates.

49. A computer-implemented method, comprising:
communicating with a plurality of sites to establish a peer-to-peer network;
determining whether each site in the plurality of sites wishes to participate in the peer-to-peer network and selecting a first group of sites in the plurality of sites for participating in the peer-to-peer network; and
connecting the first group of sites using the peer-to-peer network;
wherein at least one of the communicating, the determining and the connecting is performed by at least one process of at least one computing system.

50. The method according to claim 49, further comprising
creating at least one filter for filtering access to data of at least one site in the peer-to-peer network; and
preventing, based on the created at least one filter, at least one site in the first group of sites from accessing data of at least another site in the first group of sites.

51. The method according to claim 50, further comprising
identifying, for each site in the first group of sites, at least one principal investigator associated with the site;
wherein the plurality of identified principal investigators jointly conduct at least one of the following: a clinical study, a research project, a collaborative project, a joint venture, and/or any combination thereof.

52. A computer program product comprising a machine-readable medium storing instructions that, when executed by at least one programmable processor, cause the at least one programmable processor to perform operations comprising:
communicating with a plurality of sites to establish a peer-to-peer network;
determining whether each site in the plurality of sites wishes to participate in the peer-to-peer network and selecting a first group of sites in the plurality of sites for participating in the peer-to-peer network; and
connecting the first group of sites using the peer-to-peer network.

53. The computer program product according to claim 52, wherein the operations further comprise
creating at least one filter for filtering access to data of at least one site in the peer-to-peer network; and
preventing, based on the created at least one filter, at least one site in the first group of sites from accessing data of at least another site in the first group of sites.

54. The computer program product according to claim 53, wherein the operations further comprise
identifying, for each site in the first group of sites, at least one principal investigator associated with the site;
wherein the plurality of identified principal investigators jointly conduct at least one of the following: a clinical study, a research project, a collaborative project, a joint venture, and/or any combination thereof.

55. A system comprising:
at least one programmable processor; and
a machine-readable medium storing instructions that, when executed by the at least one programmable processor, cause the at least one programmable processor to perform operations comprising:
communicating with a plurality of sites to establish a peer-to-peer network;
determining whether each site in the plurality of sites wishes to participate in the peer-to-peer network and selecting a first group of sites in the plurality of sites for participating in the peer-to-peer network; and
connecting the first group of sites using the peer-to-peer network.

56. The system according to claim 55, wherein the operations further comprise
creating at least one filter for filtering access to data of at least one site in the peer-to-peer network; and
preventing, based on the created at least one filter, at least one site in the first group of sites from accessing data of at least another site in the first group of sites.

57. The system according to claim 56, wherein the operations further comprise
identifying, for each site in the first group of sites, at least one principal investigator associated with the site;
wherein the plurality of identified principal investigators jointly conduct at least one of the following: a clinical study, a research project, a collaborative project, a joint venture, and/or any combination thereof.
